(19) United States
(12) Patent Application Publication
(10) Pub. No.: US 2025/0304828 A1
(43) Pub. Date: Oct. 2, 2025

(54) POLISHING COMPOSITION, POLISHING METHOD, AND POLISHING SYSTEM

(71) Applicant: FUJIMI INCORPORATED, Aichi (JP)

(72) Inventors: Hiroyuki Ishida, Aichi (JP); Tomohiro Hayashi, Aichi (JP); Hitoshi Morinaga, Aichi (JP)

(21) Appl. No.: 19/092,125

(22) Filed: Mar. 27, 2025

(30) Foreign Application Priority Data
Mar. 28, 2024 (JP) 2024-054024
Mar. 25, 2025 (JP) 2025-049365

(51) Int. Cl. C09G 1/02

(52) U.S. Cl. CPC C09G 1/02

(57) ABSTRACT

The present disclosure provides a polishing composition used for polishing an object to be polished containing a resin material, wherein a silica particle, and water are contained, and the silica particle has a secondary particle size D₅₀ of 50 nm or more.

### CROSS-REFERENCE TO RELATED APPLICATION

The present application is based on Japanese Patent Application No. 2024-054024 filed on Mar. 28, 2024 and Japanese Patent Application No. 2025-049365 filed on Mar. 25, 2025, the disclosure content of which is incorporated herein by reference in its entirety.

### BACKGROUND

### 1. Technical Field

The present invention relates to a polishing composition, a polishing method, and a polishing system.

### 2. Description of Related Arts

Planarization techniques are used to increase the flatness of various base material surfaces. Chemical mechanical polishing (CMP) is one of planarization techniques often used in the semiconductor industry and the like. The chemical mechanical polishing technique is a method for planarizing the surface of an object to be polished (polishing target) such as a semiconductor substrate using a polishing composition containing abrasive grains such as silica and ceria, a corrosion inhibitor, a surfactant, and the like.

Further, a base material containing a resin material (hereinafter “object to be polished containing a resin material”) has also become widespread. Therefore, the need for a polishing composition applied to polish an object to be polished containing a resin material is gradually increasing. For example, JP 2008-537704 W (corresponding to US 2006/0228999 A) discloses a polishing composition for polishing an object to be polished containing an abrasive grain, a pyrrolidone compound, and/or polyvinyl caprolactam and containing a resin material.

### SUMMARY

The surface of the object to be polished containing a resin material is generally finished to a high quality through a lapping step and a subsequent polishing step. After the lapping step, many defects exist on the surface of the object to be polished. For the purpose of reducing this defect, in the polishing step, the polishing pad is pressed against the surface of the object to be polished, and the polishing composition is supplied to the interface to polish the object to be polished. In this case, there is a concern that the polishing efficiency may be reduced or thickness unevenness of the object to be polished after polishing (also referred to as “polished object to be polished”) may occur due to local variations in the polishing effect in the object to be polished.

Therefore, for an object to be polished containing a resin material, a polishing composition capable of reducing thickness unevenness of the object to be polished after polishing while efficiently polishing the resin material is required. However, at present, satisfactory polishing compositions have not been obtained yet.

Therefore, an object of the present invention is to provide means capable of reducing the thickness unevenness of the object to be polished after polishing while polishing the resin material at high speed in polishing the object to be polished including the resin material.

The inventors of the present disclosure have conducted intensive studies to solve the above problems. As a result, the present inventors have found that the above problems can be solved by the following means, and have completed the present invention.

That is, the above problem of the present invention can be solved by a polishing composition used for polishing an object to be polished containing a resin material, wherein a silica particle, and water are contained, and the silica particle has a secondary particle size D₅₀ of 50 nm or more.

### DETAILED DESCRIPTION

Hereinafter, embodiments of the present invention will be described. The embodiments illustrated herein are illustrated to embody the technical idea of the present invention, and do not limit the present invention. Therefore, other embodiments, usage methods, operation techniques, and the like that can be implemented by those skilled in the art and the like without departing from the gist of the present invention are all included in the scope and gist of the present invention and included in the invention described in the claims and the scope of equivalents thereof. The embodiments described in the present specification may be other embodiments by being combined in any manner.

In the present specification, “X to Y” means that numerical values (X and Y) described before and after the “X or more and Y or less” are included as a lower limit value and an upper limit value. In a case where a plurality of terms “X to Y” are described, for example, in a case where “X1 to Y1, or X2 to Y2” is described, a disclosure with each numerical value as an upper limit, a disclosure with each numerical value as a lower limit, and a combination of the upper limit and the lower limit are all disclosed (that is, these are lawful basis for amendment). Specifically, all of the correction to X1 or more, the correction to Y2 or less, the correction to X1 or less, the correction to Y2 or more, the correction to X1 to X2, the correction to X1 to Y2, and the like must all be deemed lawful. In the present specification, unless otherwise specified, in measurements of physical properties and the like, measurements are performed under conditions of room temperature (a range of 20° C. or more and 25° C. or less)/relative humidity of 40% RH or more and 50% RH or less. Also, in a case where features or aspects of the present disclosure are described in terms of Markush groups, those skilled in the art will recognize that the present disclosure is thereby described from the viewpoint of any individual component or subgroup of components of a Markush group. It should also be understood that all embodiments and combinations of descriptions disclosed herein are disclosed in the present application. That is, it should be understood that it can be a basis for the amendment.

According to a first aspect of the present invention, there is provided a polishing composition used for polishing an object to be polished containing a resin material, wherein a silica particle, and water are contained, and the silica particle has a secondary particle size D₅₀ of 50 nm or more.

According to a second aspect of the present invention, there is provided a polishing composition used for polishing an object to be polished containing a resin material, wherein a silica particle, a polishing accelerator, and water are contained, the polishing accelerator is one or more selected from the group consisting of a monovalent acid aluminum salt, a pyrrolidone compound, and a caprolactam compound, and in the silica particles, a shape irregularity N represented by the shape irregularity N=SA/SA′ is 1.5 or more, when a particle size at which a cumulative frequency from a small particle size side in a volume-based particle size distribution is 50% is defined as D₅₀, a BET specific surface area is defined as SA, and a theoretical specific surface area calculated from the D₅₀ is defined as SA′.

The polishing composition according to the first aspect and the second aspect having the above configuration reduces the thickness unevenness of the object to be polished after polishing while polishing the resin material at high speed.

According to a third aspect of the present invention, there is provided a polishing method including a step of supplying a polishing composition between an object to be polished containing a resin material and a polishing pad to polish the object, wherein the polishing composition contains silica particle and water, and the silica particle has a secondary particle size D₅₀ of 50 nm or more.

According to a fourth aspect of the present invention, there is provided a polishing method including a step of supplying a polishing composition between an object to be polished containing a resin material and a polishing pad to polish the object, wherein the polishing composition contains a silica particle, a polishing accelerator, and water, the polishing accelerator is one or more selected from the group consisting of a monovalent acid aluminum salt, a pyrrolidone compound, and a caprolactam compound, and in the silica particles, a shape irregularity N represented by the shape irregularity N=SA/SA′ is 1.5 or more, when a particle size at which a cumulative frequency from a small particle size side in a volume-based particle size distribution is 50% is defined as D₅₀, a BET specific surface area is defined as SA, and a theoretical specific surface area calculated from the D₅₀ is defined as SA′.

According to a fifth aspect of the present invention, there is provided a polishing system including an object to be polished containing a resin material, a polishing pad, and a polishing composition, wherein the polishing composition contains a silica particle, and water; and the silica particle has a secondary particle size D₅₀ of 50 nm or more; and a surface of the object to be polished is brought into contact with the polishing pad and the polishing composition.

According to a sixth aspect of the present invention, there is provided a polishing system including an object to be polished containing a resin material, a polishing pad, and a polishing composition, wherein the polishing composition contains a silica particle, a polishing accelerator, and water; the polishing accelerator is one or more selected from the group consisting of a monovalent acid aluminum salt, a pyrrolidone compound, and a caprolactam compound; and in the silica particles, a shape irregularity N represented by the shape irregularity N=SA/SA′ is 1.5 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′; and a surface of the object to be polished is brought into contact with the polishing pad and the polishing composition.

According to the polishing method and/or polishing system having the configurations of the third to sixth aspects, it is possible to reduce the thickness unevenness of the object to be polished after polishing while polishing the resin material at high speed.

Hereinafter, the present invention will be described in detail. In present specification, the explanation of “the polishing composition according to present aspect” is common to the first to sixth embodiments. In the present specification, the “polishing removal rate” is synonymous with the “polishing removal rate” and the “polishing rate”.

### [Object to be Polished]

The object to be polished applied to the polishing composition according to the present aspect contains a resin material. The polishing composition according to the present aspect is particularly suitable for polishing a base material formed of a resin material, and the technical effect of the present invention is fully exhibited when such a base material is polished.

The resin material contained in the object to be polished is not particularly limited, and examples thereof include poly(meth)acrylate ((meth)acrylic resin) such as polymethyl methacrylate (PMMA) and polycyclohexyl methacrylate (PCHMA); polyethylene terephthalate (PET); polycarbonate (PC); polyvinyl chloride (PVC); polystyrene (PS); thiourethane-based resin; polysulfide; episulfide resin; polyolefins such as polyethylene (PE), ultra high molecular weight polyethylene (UHMWPE), and polypropylene (PP); polyurea urethane; poly(meth)(thio)acrylate; allyl diglycidyl carbonate; polybenzoxazole (PBO); polybutylene terephthalate (PBT); polyimide (PI); polyamide (PA); epoxy resin; urethane acrylate resin; polyester resin; unsaturated polyester resin; phenol resin; polynorbornene resin; polyacetal (POM); modified polyphenylene ether (m-PPE); syndiotactic polystyrene (SPS); amorphous polyarylate (PAR); polysulfone (PSF); polyethersulfone (PES); polyphenylene sulfide (PPS); polyetheretherketone (PEEK); polyetherimide (PEI); benzocyclobutene (BCB); fluorine resin; and liquid crystal polymer (LCP).

In the polishing composition of the present aspect, the resin material contained in the object to be polished is preferably an optical resin. That is, according to one embodiment, in the polishing composition of the present aspect, the resin material is an optical resin material. Optical resins are light-transmissive resins, and are used as materials constituting optical members (for example, films and substrates used in liquid crystal display devices, prism sheets, and the like; lenses in the signal reading lens systems of optical disk devices; Fresnel lenses for projection screens; and lenticular lenses) having a shape such as a film shape, a plate shape (for example, optical waveguides in surface light source devices such as liquid crystal screens, luminous displays, luminous signs, labels, and lighting, diffusion plates, light guide plates (waveguides), and polarizing plates), and a lens shape, which are used in various optical-related devices.

Examples of such optical resins (light-transmissive resins) include poly(meth)acrylates ((meth)acrylic resins) such as polymethyl methacrylate (PMMA) and polycyclohexyl methacrylate (PCHMA); polyethylene terephthalate (PET); polycarbonate (PC); polyvinyl chloride (PVC); polystyrene (PS); thiourethane-based resins; polysulfides; episulfide resins; polyolefins such as polyethylene (PE), ultra high molecular weight polyethylene (UHMWPE), and polypropylene (PP); polyurea urethane; poly(meth)(thio)acrylates; allyl diglycidyl carbonate; polyimide (PI); polyamide (PA); polyester resins; and derivatives thereof. Therefore, the polishing composition of the present aspect is preferably used for polishing an object to be polished containing one or more selected from the group consisting of poly(meth)acrylate (preferably, polymethyl methacrylate (PMMA), polycyclohexyl methacrylate (PCHMA), or the like), polyethylene terephthalate (PET), polycarbonate (PC), polyvinyl chloride (PVC), polystyrene (PS), a thiourethane-based resin, polysulfide, episulfide resin, polyolefin (preferably, polyethylene (PE), ultra high molecular weight polyethylene (UHMWPE), polypropylene (PP), and the like), polyurea urethane, poly(meth)(thio)acrylate, allyl diglycidyl carbonate, polyimide (PI), polyamide (PA), polyester resin, and derivatives thereof. As a result, the effect of reducing the thickness unevenness of the object to be polished after polishing can be efficiently exhibited while polishing the resin material at high speed.

The resin material contained in the object to be polished preferably contains one or more selected from the group consisting of thiourethane-based resin, episulfide resin, polycarbonate, polymethyl methacrylate, and polypropylene. The resin materials may be used alone or in combination of two or more types thereof. When the object to be polished contains the resin material, the effect of reducing the thickness unevenness of the object to be polished after polishing can be efficiently exhibited while polishing the resin material at high speed.

The polishing composition according to the present aspect can efficiently exhibit the effect of reducing the thickness unevenness of the object to be polished after polishing while polishing the resin material at high speed by polishing the object to be polished having a small thickness. That is, the thickness of the object to be polished (object to be polished before polishing) is preferably 3.0 mm or less, more preferably 2.0 mm or less, still more preferably 1.0 mm or less, particularly preferably 0.8 mm or less, and most preferably 0.6 mm or less. According to one embodiment, in the polishing composition according to the present aspect, the object to be polished before polishing has an average thickness of 1 mm or less. In polishing with the polishing composition according to the present aspect, the thickness change of the object to be polished before and after polishing can be approximately 0.1 mm. Accordingly, the thickness of the object to be polished (object to be polished after polishing) is preferably 3.0 mm or less, more preferably 2.0 mm or less, still more preferably 1.0 mm or less, still further more preferably 0.9 mm or less, particularly preferably 0.8 mm or less, and most preferably 0.6 mm or less. According to one embodiment, in the polishing composition according to the present aspect, the object to be polished after polishing has an average thickness of 1 mm or less. In the present specification, the average thickness of the object to be polished can be measured with a micrometer or the like.

In the polishing composition according to the present aspect, the object to be polished (object to be polished before polishing) is preferably flat. In the present specification, the term “flat” means that a global backside ideal range (GBIR) measured in Examples to be described later is less than 2.0 μm. The GBIR of the object to be polished (object to be polished before polishing) is more preferably 1.5 μm or less, still more preferably 1.2 μm, particularly preferably 1.0 μm or less, and most preferably 0.8 μm or less. The lower limit of the GBIR is 0 μm. GBIR represents a distance from a maximum height to a minimum height by adsorbing the entire back surface of the object to be polished to a flat chuck surface, measuring the height of the entire surface of the wafer from the reference surface with the back surface as the reference surface. For the GBIR, a value obtained by a measurement method described in Examples to be described later is adopted.

Therefore, the polishing composition according to the present aspect is suitable for polishing an object to be polished (object to be polished before polishing) that is flat (that is, GBIR is less than 2.0 μm) and has a thickness of 1.5 mm or less (preferably 1 mm or less, more preferably 1.0 mm or less, further preferably 0.8 mm or less, especially preferably 0.7 mm or less, and most preferably 0.6 mm or less). As a result, the effect of reducing the thickness unevenness of the object to be polished after polishing can be efficiently exhibited while polishing the resin material at high speed.

### [Polishing Composition]

In the present invention, the polishing composition includes a first aspect and a second aspect. In the following, the constitution of the main components contained in the polishing composition according to the first aspect and the constitution of the main components contained in the polishing composition according to the second aspect will be described in order.

### <Polishing Composition According to First Aspect>

The polishing composition according to the first aspect is a polishing composition used for polishing an object to be polished containing a resin material, wherein a silica particle, and water are comprised, and the silica particle has a secondary particle size D₅₀ of 50 nm or more.

### [Silica Particles]

The polishing composition according to the first aspect contains silica particles as abrasive grains. The abrasive grains mechanically polish the object to be polished and improve the polishing removal rate. The silica particles have a moderate hardness to reduce defects in the resin material.

### <Secondary Particle Size D₅₀>

In the polishing composition according to the first aspect, the D₅₀ of the silica particles (a particle size at which a cumulative frequency from a small particle size side is 50% in a volume-based particle size distribution (secondary particle size at which a cumulative frequency from a small particle size side is 50%) is 50 nm or more (0.05 μm or more). If the D₅₀ of the silica particles is less than 50 nm, the polishing removal rate of the resin material (object to be polished) decreases.

In the polishing of an object to be polished containing a resin material, the object to be polished is first polished through a lapping step to adjust the thickness, and at that time, many defects remain on the surface of the object to be polished. For the purpose of reducing these defects, the surface of the object to be polished is polished with the polishing composition in the polishing step, but there is a concern that thickness unevenness due to polishing may occur in the object to be polished due to local variations in the polishing effect in the object to be polished. For example, as the polishing time elapses, the supplied polishing composition is accumulated in the outer edge portion of the object to be polished, and the local variation in the polishing effect further increases. That is, as it takes more time to reduce defects in the polishing step, the thickness unevenness tends to increase. Therefore, in the object to be polished containing a resin material, a higher polishing removal rate is required. The present inventors have found that the abrasive grains having the specific size can provide a remarkably high polishing removal rate to reduce the thickness unevenness of the object to be polished after polishing. In other words, according to the polishing composition of the first aspect, it is possible to reduce the local variation in the polishing effect that may occur at the time of polishing and to maintain or improve the flatness of the object to be polished while performing polishing at a remarkably high polishing removal rate. In addition, according to the polishing composition of the first aspect, it was also found that the surface roughness (Rms) of the surface of the object to be polished after polishing is low, and there are few scratches on the surface of the object to be polished after polishing. That is, according to the polishing composition of the first aspect, defects on the surface of the object to be polished can be reduced, and the surface quality of the object to be polished after polishing can also be improved.

As described above, by having D₅₀ of the silica particles of 50 nm or more (0.05 μm or more), it is possible to more efficiently improve the polishing removal rate of the resin material and reduce the unevenness in the thickness of the polished object after polishing. The D₅₀ of the silica particles is preferably more than 0.05 μm (more than 50 nm), more preferably 0.06 μm or more, still more preferably 0.08 μm or more, particularly preferably 0.1 μm or more, and most preferably 0.15 μm or more. In addition, the D₅₀ of the silica particles is preferably 1 μm or less, may be 0.8 μm or less, more preferably 0.5 μm or less, still more preferably 0.3 μm or less, particularly preferably 0.25 μm or less, and most preferably 0.2 μm or less. According to one embodiment, the silica particles have D₅₀ of 50 nm or more and less than 200 nm.

D₁₀ of the silica particles is a particle size at which a cumulative frequency from a small particle size side is 10% in a volume-based particle size distribution (secondary particle size at which a cumulative frequency from a small particle size side is 10%). The D₁₀ of the silica particles is not particularly limited as long as D₅₀ of the silica particles is 50 nm or more, but is preferably 0.005 μm or more, more preferably 0.01 μm or more, still more preferably 0.02 μm or more, particularly preferably 0.05 μm or more, and most preferably 0.07 μm or more. In addition, the D₁₀ of the silica particles is preferably 0.5 μm or less, may be 0.3 μm or less, more preferably 0.25 m or less, further preferably 0.2 μm or less, particularly preferably 0.15 μm or less, and most preferably 0.13 μm or less. When the D₁₀ of the silica particles is within the above range, it is possible to more efficiently improve the polishing removal rate of the resin material and reduce the thickness unevenness of the object to be polished after polishing.

D₉₀ of the silica particles is a particle size at which a cumulative frequency from a small particle size side is 90% in a volume-based particle size distribution (secondary particle size at which a cumulative frequency from a small particle size side is 90%). The D₉₀ of the silica particles is not particularly limited as long as D₅₀ of the silica particles is 50 nm or more, but is preferably 0.1 μm or more, more preferably 0.12 μm or more, still more preferably 0.15 μm or more, particularly preferably 0.2 μm or more, and most preferably 0.3 μm or more. In addition, the D₉₀ of the silica particles is preferably 1.5 μm or less, may be 1.2 μm or less, more preferably 1.0 m or less, further preferably 0.8 μm or less, particularly preferably 0.7 μm or less, and most preferably 0.5 μm or less. When the D₉₀ of the silica particles is within the above range, it is possible to more efficiently improve the polishing removal rate of the resin material and reduce the thickness unevenness of the object to be polished after polishing.

The ratio of D₉₀ to D₁₀ of the silica particles (hereinafter “D₉₀/D₁₀”) is preferably 1.2 or more, more preferably 1.5 or more, still more preferably 1.8 or more, particularly preferably 2.0 or more, and most preferably 2.5 or more. In addition, the D₉₀/D₁₀ of the silica particles is preferably 6.5 or less, more preferably 6.0 or less, still more preferably 5.0 or less, further preferably 4.0 or less, and particularly preferably 3.5 or less. When the D₉₀/D₁₀ of the silica particles is within the above range, it is possible to more efficiently improve the polishing removal rate of the resin material and reduce the thickness unevenness of the object to be polished after polishing.

According to an embodiment, in the polishing composition of the first aspect, a ratio of D₉₀ to D₁₀ of the silica particles (D₉₀/D₁₀) is 2.0 or more, when a particle size at which a cumulative frequency from a small particle size side in a volume-based particle size distribution of the silica particles is 10% is defined as D₁₀, and a particle size at which a cumulative frequency from a small particle size side in a volume-based particle size distribution of the silica particles is 90% is defined as D₉₀.

The D₁₀, D₅₀, and D₉₀ of the silica particles can be determined by a dynamic light scattering method, a laser diffraction method, a laser scattering method, a pore electric resistance method, or the like. In the present specification, in a volume-based particle size distribution measured using a laser diffraction particle size distribution measuring apparatus, values obtained from a particle size at which a cumulative frequency from a small particle size side is 10%, a particle size at which a cumulative frequency from a small particle size side is 50%, and a particle size at which a cumulative frequency from a small particle size side is 90% are respectively employed as the D₁₀, D₅₀, and D₉₀. More specifically, the volume-based particle size distribution can be measured by the method described in Examples.

### <Shape Irregularity N>

In the silica particles contained in the polishing composition according to the first aspect, a shape irregularity N represented by N=SA/SA′ is 1.2 or more when a particle size at which a cumulative frequency from a small particle size side in a volume-based particle size distribution is 50% is defined as D₅₀, a BET specific surface area is defined as SA, and a theoretical specific surface area calculated from D₅₀ is defined as SA′. The shape irregularity N is a parameter indicating the degree of irregularity of the outer shape of the particle with respect to a true sphere having a similar particle size, and the larger the shape irregularity N exceeds 1, the larger the degree of irregularity of the particle shape. When the shape irregularity N is 1, the particle is a true sphere. In the silica particles according to the first aspect, since the shape irregularity N is preferably 1.2 or more (more preferably 1.5 or more), the degree of irregularity of the particle shape is large.

In the polishing of an object to be polished containing a resin material, the inventors have intensively studied how to reduce the thickness unevenness while reducing the surface defects of the object due to the lapping process, and have found that the irregular shape of the abrasive grains can bring about a significantly high polishing rate and reduce the thickness unevenness of the object to be polished after polishing. When the shape irregularity N of the silica particles is 1.2 or more, the defects on the surface of the object to be polished can be reduced, and the surface quality of the object after polishing can be improved. The upper limit of the shape irregularity N of the silica particles is not particularly limited, but is practically 3.0 or less. That is, the shape irregularity N of the silica particles is preferably 1.6 or more, more preferably 1.7 or more, still more preferably 1.8 or more, and particularly preferably 1.9 or more.

The BET specific surface area SA of the silica particles and the theoretical specific surface area SA′ of the silica particles used in calculating the irregularity N can be calculated in the same manner as described in the polishing composition of the second aspect described below.

The shape of the silica particles is not particularly limited. Specific examples of the shape of the silica particles include various shapes such as a polygonal columnar shape such as a triangular prism and a quadrangular prism, a columnar shape, a barrel shape in which the central portion of the cylinder bulges more than the end portions, a donut shape in which a central portion of a disk penetrates, a plate shape, a so-called cocoon shape having a constriction at the central portion, a so-called associated spherical shape in which a plurality of particles are integrated, a so-called Konpeito shape having a plurality of protrusions on the surface thereof, a rugby ball shape, a cone shape, a truncated cone shape, a pyramid shape, a truncated pyramid shape, a hemisphere shape, a needle shape, and an irregular shape.

The concentration (content) of the silica particles in the polishing composition is not particularly limited, but is preferably 0.1% by mass or more, more preferably 0.5% by mass or more, still more preferably 1% by mass or more, further preferably 2% by mass or more, particularly preferably 5% by mass or more, and most preferably 10% by mass or more with respect to the total mass of the polishing composition. As the concentration of the silica particles increases, the polishing removal rate is further improved, and the thickness unevenness of the object to be polished after polishing can be reduced. In addition, the concentration (content) of the silica particles is preferably 50% by mass or less, more preferably 40% by mass or less, still more preferably 35% by mass or less, further preferably 30% by mass or less, particularly preferably 25% by mass or less, and most preferably 20% by mass or less with respect to the total mass of the polishing composition. Within the above range, the polishing removal rate of the resin material can be further improved, and the thickness unevenness of the object to be polished after polishing can be reduced. One preferable example of the concentration (content) of the silica particles is preferably 0.1% by mass or more and 50% by mass or less, more preferably 0.5% by mass or more and 40% by mass or less, still more preferably 1% by mass or more and 35% by mass or less, further preferably 2% by mass or more and 30% by mass or less, particularly preferably 5% by mass or more and 25% by mass or less, and most preferably 10% by mass or more and 20% by mass or less with respect to the total mass of the polishing composition. These silica particles may be used alone or in combination of two or more types thereof. When two or more types of silica particles are used, the concentration (content) of the silica particles is the total amount.

The silica particles are preferably colloidal silica. Examples of the method for manufacturing colloidal silica include a sodium silicate method and a sol-gel method, and colloidal silica manufactured by any manufacturing method is suitably used. In order to set D₅₀ of the silica particles (preferably colloidal silica) to 50 nm or more, it can be appropriately controlled by selecting the conditions (for example, reaction temperature, reaction concentration, and the like) at the time of manufacturing. As the silica particles, a commercially available product may be used. In this case, the silica particles to be used in the polishing composition of the first aspect can be selected by measuring D₅₀ of the silica particles.

In addition, D₁₀, D₅₀, and D₉₀ of the silica particles can also be appropriately controlled by selecting conditions at the time of manufacturing the silica particles.

### [Polishing Accelerator]

The polishing composition of the first aspect contains preferably a polishing accelerator. The polishing accelerator is one or more selected from the group consisting of a monovalent acid aluminum salt, a pyrrolidone compound, and a caprolactam compound. The polishing accelerator has an action of assisting polishing by abrasive grains.

Examples of the monovalent acid aluminum salt include monovalent inorganic acids and monovalent organic acid aluminum salts. Specific examples of the monovalent inorganic acid include nitric acid, hydrochloric acid, perchloric acid, nitrous acid, hypochlorous acid, hypophosphorous acid (phosphinic acid; H₂PO(OH)), and sulfamic acid. Specific examples of the monovalent organic acid include lactic acid, nicotinic acid, acetic acid, formic acid, propionic acid, valeric acid, caproic acid, caprylic acid, capric acid, cyclohexanecarboxylic acid, phenylacetic acid, benzoic acid, crotonic acid, methacrylic acid, methanesulfonic acid, ethanesulfonic acid, aminoethanesulfonic acid, benzenesulfonic acid, p-toluenesulfonic acid, 1-naphthalenesulfonic acid, and 2-naphthalenesulfonic acid. When the monovalent acid aluminum salt has hydrated water, these contents are the contents excluding the hydrated water. In addition, preferable examples of the monovalent acid aluminum salt include aluminum nitrate and aluminum chloride.

The concentration (content) of the monovalent acid aluminum salt in the polishing composition is not particularly limited, but is preferably 0.1% by mass or more, more preferably 0.5% by mass or more, still more preferably 1% by mass or more, further preferably 2% by mass or more, particularly preferably 3% by mass or more, and most preferably 5% by mass or more with respect to the total mass of the polishing composition. As the concentration of the monovalent acid aluminum salt increases, the polishing removal rate is further improved, and the thickness unevenness of the object to be polished after polishing can be reduced. In addition, the concentration (content) of the monovalent acid aluminum salt is preferably 25% by mass or less, more preferably 20% by mass or less, still more preferably 18% by mass or less, further preferably 15% by mass or less, particularly preferably 12% by mass or less, and most preferably 10% by mass or less with respect to the total mass of the polishing composition. Within the above range, the polishing removal rate of the resin material can be further improved, and the thickness unevenness of the object to be polished after polishing can be reduced. One preferable example of the concentration (content) of the monovalent acid aluminum salt is preferably 0.1% by mass or more and 25% by mass or less, more preferably 0.5% by mass or more and 20% by mass or less, still more preferably 1% by mass or more and 18% by mass or less, further preferably 2% by mass or more and 15% by mass or less, particularly preferably 3% by mass or more and 12% by mass or less, and most preferably 5% by mass or more and 10% by mass or less with respect to the total mass of the polishing composition. The monovalent acid aluminum salt may be used alone or in combination of two or more types thereof. When two or more types of monovalent acid aluminum salts are used, the concentration (content) of the monovalent acid aluminum salt is taken as the total amount.

Examples of the pyrrolidone compound include 2-pyrrolidone or a 2-pyrrolidone derivative, and a polymer having a structural unit derived from a 2-pyrrolidone derivative. Examples of the 2-pyrrolidone derivative include 2-pyrrolidone, N-octyl-2 pyrrolidone, N-dodecyl-2 pyrrolidone, N-methyl-2 pyrrolidone, N-ethyl-2 pyrrolidone, N-cyclohexyl-2 pyrrolidone, N-hydroxyethyl-2 pyrrolidone, N-butyl-2-pyrrolidone, N-hexyl-2-pyrrolidone, N-decyl-2-pyrrolidone, N-octadecyl-2-pyrrolidone, N-hexadecyl-2-pyrrolidone, and N-vinyl-2-pyrrolidone. Examples of the polymer having a structural unit derived from a 2-pyrrolidone derivative include a homopolymer (hereinafter also referred to as “polyvinylpyrrolidone” or “PVP”) or a copolymer of N-vinyl-2 pyrrolidone. These pyrrolidone compounds may be used alone or in combination of two or more types thereof. Among them, polyvinylpyrrolidone is preferable as the pyrrolidone compound.

The concentration (content) of the pyrrolidone compound in the polishing composition is not particularly limited, but is preferably 0.001% by mass or more, more preferably 0.003% by mass or more, still more preferably 0.005% by mass or more, further preferably 0.007% by mass or more, particularly preferably 0.008% by mass or more, and most preferably 0.01% by mass or more with respect to the total mass of the polishing composition. As the concentration of the pyrrolidone compound increases, the polishing removal rate is further improved, and the thickness unevenness of the object to be polished after polishing can be reduced. In addition, the concentration (content) of the pyrrolidone compound is preferably 3% by mass or less, more preferably 2% by mass or less, still more preferably 1.5% by mass or less, further preferably 1.2% by mass or less, particularly preferably 1% by mass or less, and most preferably 0.5% by mass or less with respect to the total mass of the polishing composition. Within the above range, the polishing removal rate of the resin material can be further improved, and the thickness unevenness of the object to be polished after polishing can be reduced. One preferable example of the concentration (content) of the pyrrolidone compound is preferably 0.001% by mass or more and 3% by mass or less, more preferably 0.003% by mass or more and 2% by mass or less, still more preferably 0.005% by mass or more and 1.5% by mass or less, further preferably 0.007% by mass or more and 1.2% by mass or less, particularly preferably 0.008% by mass or more and 1% by mass or less, and most preferably 0.01% by mass or more and 0.5% by mass or less with respect to the total mass of the polishing composition. When two or more types of pyrrolidone compounds are used, the concentration (content) of the pyrrolidone compounds is taken as the total amount.

In the polishing composition of the first aspect, according to one embodiment, the pyrrolidone compound is polyvinylpyrrolidone. In this case, the weight average molecular weight (Mw) of polyvinylpyrrolidone is preferably 2,000 or more, more preferably 3,000 or more, still more preferably 5,000 or more, and particularly preferably 7,500 or more. In addition, the weight average molecular weight (Mw) of polyvinylpyrrolidone is preferably 900,000 or less, more preferably 500,000 or less, still more preferably 250,000 or less, particularly preferably 100,000 or less, and most preferably 55,000 or less. When the weight average molecular weight is polyvinylpyrrolidone within the above range, it is possible to more efficiently improve the polishing removal rate of the resin material and reduce the thickness unevenness of the object to be polished after polishing.

Examples of the caprolactam compound include F-caprolactam or a derivative thereof, and a polymer having a structural unit derived from F-caprolactam or a derivative thereof. The caprolactam compound can be used as an alternative to the pyrrolidone compound. Examples of the caprolactam compound include F-caprolactam and nylon 6.

The concentration (content) of the caprolactam compound in the polishing composition is not particularly limited, but is preferably 0.01% by mass or more, more preferably 0.05% by mass or more, and still more preferably 0.1% by mass or more with respect to the total mass of the polishing composition. In addition, the concentration (content) of the caprolactam compound is preferably 5% by mass or less, more preferably 2% by mass or less, and still more preferably 1% by mass or less. When the content of the caprolactam compound is within the above range, it is possible to more efficiently improve the polishing removal rate of the resin material and reduce the thickness unevenness of the object to be polished after polishing.

The pyrrolidone compound and the caprolactam compound may be commercially available products or may be synthesized by a known method.

According to one embodiment, in the polishing composition of the first aspect, the polishing accelerator contains a monovalent acid aluminum salt and a pyrrolidone compound. When the polishing composition according to the first aspect contains a monovalent acid aluminum salt and a pyrrolidone compound as polishing accelerators, it is possible to more efficiently improve the polishing removal rate of the resin material and reduce the thickness unevenness of the object to be polished after polishing.

### [Water]

The polishing composition according to the first aspect contains water. The water disperses or dissolves each component. From the viewpoint of preventing the influence of impurities on other components of the polishing composition, it is preferable to use water having as high purity as possible. Specifically, pure water, ultrapure water, or distilled water from which impurity ions are removed with an ion exchange resin and then foreign substances are removed through a filter is more preferable. In addition, for the purpose of controlling the dispersibility or the like of other components in the polishing composition, an organic solvent or the like as a dispersing medium may be further included.

### <Polishing Composition According to Second Aspect>

The polishing composition according to the second aspect is a polishing composition used for polishing an object to be polished containing a resin material, wherein a silica particle, a polishing accelerator, and water are contained, the polishing accelerator is one or more selected from the group consisting of a monovalent acid aluminum salt, a pyrrolidone compound, and a caprolactam compound, and in the silica particles, a shape irregularity N represented by the shape irregularity N=SA/SA′ is 1.5 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′.

### [Silica Particles]

The polishing composition according to the second embodiment contains silica particles as abrasive grains. The abrasive grains mechanically polish the object to be polished and improve the polishing removal rate. The silica particles have a moderate hardness to reduce defects in the resin material.

### <Shape Irregularity N>

In the silica particles contained in the polishing composition according to the second aspect, a shape irregularity N represented by N=SA/SA′ is 1.5 or more when a particle size at which a cumulative frequency from a small particle size side in a volume-based particle size distribution is 50% is defined as D₅₀, a BET specific surface area is defined as SA, and a theoretical specific surface area calculated from D₅₀ is defined as SA′. The shape irregularity N is a parameter indicating the degree of irregularity of the outer shape of the particle with respect to a true sphere having a similar particle size, and the larger the shape irregularity N exceeds 1, the larger the degree of irregularity of the particle shape. When the shape irregularity N is 1, the particle is a true sphere. In the silica particles according to the second aspect, since the shape irregularity N is 1.5 or more, the degree of irregularity of the particle shape is large.

In the polishing of an object to be polished containing a resin material, the object to be polished is first polished through a lapping step to adjust the thickness, and at that time, many defects remain on the surface of the object to be polished. For the purpose of reducing these defects, the surface of the object to be polished is polished with the polishing composition in the polishing step, but there is a concern that thickness unevenness due to polishing may occur in the object to be polished due to local variations in the polishing effect in the object to be polished. For example, as the polishing time elapses, the supplied polishing composition is accumulated in the outer edge portion of the object to be polished, and the local variation in the polishing effect further increases. That is, as it takes more time to reduce defects in the polishing step, the thickness unevenness tends to increase. Therefore, in the object to be polished containing a resin material, a higher polishing removal rate is required. Normally, it is known that abrasive grains having a relatively large size have a high polishing removal rate, and it is known that the polishing removal rate increases as the irregularity of the shape of the abrasive grains and the aspect ratio increase. The present inventors have found that these irregularities of the shape of the abrasive grains can provide a remarkably high polishing removal rate in the presence of a specific polishing accelerator to reduce the thickness unevenness of the object to be polished after polishing. In other words, according to the polishing composition of the second aspect, it is possible to reduce the local variation in the polishing effect that may occur at the time of polishing and to maintain or improve the flatness of the object to be polished while performing polishing at a remarkably high polishing removal rate. In addition, according to the polishing composition of the second aspect, it has also been found that there are few scratches on the surface of the object to be polished after polishing. That is, according to the polishing composition of the second aspect, defects on the surface of the object to be polished can be reduced, and the surface quality of the object to be polished after polishing can also be improved.

When the shape irregularity N of the silica particles is less than 1.5, the polishing removal rate of the resin material (object to be polished) decreases. The upper limit of the shape irregularity N of the silica particles is not particularly limited, but is practically 3.0 or less. That is, the shape irregularity N of the silica particles is preferably 1.6 or more, more preferably 1.7 or more, still more preferably 1.8 or more, and particularly preferably 1.9 or more.

The BET specific surface area SA of the silica particles used for calculating the shape irregularity N is a specific surface area measured based on JIS Z8830:2013. More specifically, the BET specific surface area SA can be measured by the method described in Examples.

In addition, the theoretical specific surface area SA′ of the silica particles is a value calculated by the following Formula (1) using the particle size at which the cumulative frequency from the small particle size side is 50% in the volume-based particle size distribution as the value of D₅₀.

$$\begin{matrix}[ Formula 1 ] & \\ Theoretical specific surface area SA ’ = \frac{6}{ρ \times {D}_{50}} & ( 1 )\end{matrix}$$

In the above Formula (1), ρ is the density of silica particles, and a value of 1.80 to 2.20 g/cm³ is used. The density of the silica particles can be calculated, for example, by a method described in WO 2018/012176 (true density of silica).

Here, D₅₀ of the silica particles is a particle size at which a cumulative frequency from a small particle size side is 50% in a volume-based particle size distribution (secondary particle size at which a cumulative frequency from a small particle size side is 50%). The D₅₀ of the silica particles is not particularly limited as long as the shape irregularity N is 1.5 or more, but is preferably 0.05 μm or more, more preferably 0.06 μm or more, still more preferably 0.08 μm or more, particularly preferably 0.1 μm or more, and most preferably 0.15 μm or more. In addition, the D₅₀ of the silica particles is preferably 1 μm or less, may be 0.8 μm or less, more preferably 0.5 μm or less, further preferably 0.3 μm or less, particularly preferably 0.25 μm or less, and most preferably 0.2 μm or less. According to one embodiment, the silica particles have a D₅₀ of 50 nm or more and less than 200 nm. When the D₅₀ of the silica particles is within the above range, it is possible to more efficiently improve the polishing removal rate of the resin material and reduce the thickness unevenness of the object to be polished after polishing.

D₁₀ of the silica particles is a particle size at which a cumulative frequency from a small particle size side is 10% in a volume-based particle size distribution (secondary particle size at which a cumulative frequency from a small particle size side is 10%). The D₁₀ of the silica particles is not particularly limited as long as the shape irregularity N is 1.5 or more, but is preferably 0.005 m or more, more preferably 0.01 μm or more, still more preferably 0.02 μm or more, particularly preferably 0.05 μm or more, and most preferably 0.07 μm or more. In addition, the D₁₀ of the silica particles is preferably 0.5 μm or less, may be 0.3 μm or less, more preferably 0.25 μm or less, further preferably 0.2 μm or less, particularly preferably 0.15 μm or less, and most preferably 0.13 μm or less. When the D₁₀ of the silica particles is within the above range, it is possible to more efficiently improve the polishing removal rate of the resin material and reduce the thickness unevenness of the object to be polished after polishing.

D₉₀ of the silica particles is a particle size at which a cumulative frequency from a small particle size side is 90% in a volume-based particle size distribution (secondary particle size at which a cumulative frequency from a small particle size side is 90%). The D₉₀ of the silica particles is not particularly limited as long as the shape irregularity N is 1.5 or more, but is preferably 0.1 m or more, more preferably 0.12 μm or more, still more preferably 0.15 μm or more, particularly preferably 0.2 μm or more, and most preferably 0.3 μm or more. In addition, the D₉₀ of the silica particles is preferably 1.5 μm or less, may be 1.2 μm or less, more preferably 1.0 μm or less, further preferably 0.8 μm or less, particularly preferably 0.7 μm or less, and most preferably 0.5 μm or less. When the D₉₀ of the silica particles is within the above range, it is possible to more efficiently improve the polishing removal rate of the resin material and reduce the thickness unevenness of the object to be polished after polishing.

The ratio of D₉₀ to D₁₀ of the silica particles (hereinafter “D₉₀/D₁₀”) is preferably 1.2 or more, more preferably 1.5 or more, still more preferably 1.8 or more, particularly preferably 2.0 or more, and most preferably 2.5 or more. In addition, the D₉₀/D₁₀ of the silica particles is preferably 6.5 or less, more preferably 6.0 or less, still more preferably 5.0 or less, further preferably 4.0 or less, and particularly preferably 3.5 or less. When the D₉₀/D₁₀ of the silica particles is within the above range, it is possible to more efficiently improve the polishing removal rate of the resin material and reduce the thickness unevenness of the object to be polished after polishing.

According to an embodiment, in the polishing composition of the second aspect, a ratio of D₉₀ to D₁₀ of the silica particles (D₉₀/D₁₀) is 2.0 or more, when a particle size at which a cumulative frequency from a small particle size side in a volume-based particle size distribution of the silica particles is 10% is defined as D₁₀, and a particle size at which a cumulative frequency from a small particle size side in a volume-based particle size distribution of the silica particles is 90% is defined as D₉₀.

The D₁₀, D₅₀, and D₉₀ of the silica particles can be determined by a dynamic light scattering method, a laser diffraction method, a laser scattering method, a pore electric resistance method, or the like. In the present specification, in a volume-based particle size distribution measured using a laser diffraction particle size distribution measuring apparatus, values obtained from a particle size at which a cumulative frequency from a small particle size side is 10%, a particle size at which a cumulative frequency from a small particle size side is 50%, and a particle size at which a cumulative frequency from a small particle size side is 90% are respectively employed as the D₁₀, D₅₀, and D₉₀. More specifically, the volume-based particle size distribution can be measured by the method described in Examples.

The shape of the silica particles is not particularly limited as long as the shape irregularity N is 1.5 or more. Specific examples of the shape of the silica particles include various shapes such as a polygonal columnar shape such as a triangular prism and a quadrangular prism, a columnar shape, a barrel shape in which the central portion of the cylinder bulges more than the end portions, a donut shape in which a central portion of a disk penetrates, a plate shape, a so-called cocoon shape having a constriction at the central portion, a so-called associated spherical shape in which a plurality of particles are integrated, a so-called Konpeito shape having a plurality of protrusions on the surface thereof, a rugby ball shape, a cone shape, a truncated cone shape, a pyramid shape, a truncated pyramid shape, a hemisphere shape, a needle shape, and an irregular shape.

The concentration (content) of the silica particles in the polishing composition is not particularly limited, but is preferably 0.1% by mass or more, more preferably 0.5% by mass or more, still more preferably 1% by mass or more, further preferably 2% by mass or more, particularly preferably 5% by mass or more, and most preferably 10% by mass or more with respect to the total mass of the polishing composition. As the concentration of the silica particles increases, the polishing removal rate is further improved, and the thickness unevenness of the object to be polished after polishing can be reduced. In addition, the concentration (content) of the silica particles is preferably 50% by mass or less, more preferably 40% by mass or less, still more preferably 35% by mass or less, further preferably 30% by mass or less, particularly preferably 25% by mass or less, and most preferably 20% by mass or less with respect to the total mass of the polishing composition. Within the above range, the polishing removal rate of the resin material can be further improved, and the thickness unevenness of the object to be polished after polishing can be reduced. One preferable example of the concentration (content) of the silica particles is preferably 0.1% by mass or more and 50% by mass or less, more preferably 0.5% by mass or more and 40% by mass or less, still more preferably 1% by mass or more and 35% by mass or less, further preferably 2% by mass or more and 30% by mass or less, particularly preferably 5% by mass or more and 25% by mass or less, and most preferably 10% by mass or more and 20% by mass or less with respect to the total mass of the polishing composition. These silica particles may be used alone or in combination of two or more types thereof. When two or more types of silica particles are used, the concentration (content) of the silica particles is the total amount.

The silica particles are preferably colloidal silica. Examples of the method for manufacturing colloidal silica include a sodium silicate method and a sol-gel method, and colloidal silica manufactured by any manufacturing method is suitably used. In order to set the shape irregularity N of the silica particles (preferably colloidal silica) to 1.5 or more, it can be appropriately controlled by selecting the conditions (for example, reaction temperature, reaction concentration, and the like) at the time of manufacturing. As the silica particles, a commercially available product may be used. In this case, the silica particles to be used in the polishing composition of the second aspect can be selected by measuring the shape irregularity N of the silica particles.

In addition, D₁₀, D₅₀, and D₉₀ of the silica particles can also be appropriately controlled by selecting conditions at the time of manufacturing the silica particles.

### [Polishing Accelerator]

The polishing composition of the second aspect contains a polishing accelerator. The polishing accelerator is one or more selected from the group consisting of a monovalent acid aluminum salt, a pyrrolidone compound, and a caprolactam compound. The polishing accelerator has an action of assisting polishing by abrasive grains.

Examples of the monovalent acid aluminum salt include monovalent inorganic acids and monovalent organic acid aluminum salts. Specific examples of the monovalent inorganic acid include nitric acid, hydrochloric acid, perchloric acid, nitrous acid, hypochlorous acid, hypophosphorous acid (phosphinic acid; H₂PO(OH)), and sulfamic acid. Specific examples of the monovalent organic acid include lactic acid, nicotinic acid, acetic acid, formic acid, propionic acid, valeric acid, caproic acid, caprylic acid, capric acid, cyclohexanecarboxylic acid, phenylacetic acid, benzoic acid, crotonic acid, methacrylic acid, methanesulfonic acid, ethanesulfonic acid, aminoethanesulfonic acid, benzenesulfonic acid, p-toluenesulfonic acid, 1-naphthalenesulfonic acid, and 2-naphthalenesulfonic acid. When the monovalent acid aluminum salt has hydrated water, these contents are the contents excluding the hydrated water. In addition, preferable examples of the monovalent acid aluminum salt include aluminum nitrate and aluminum chloride.

The concentration (content) of the monovalent acid aluminum salt in the polishing composition is not particularly limited, but is preferably 0.1% by mass or more, more preferably 0.5% by mass or more, still more preferably 1% by mass or more, further preferably 2% by mass or more, particularly preferably 3% by mass or more, and most preferably 5% by mass or more with respect to the total mass of the polishing composition. As the concentration of the monovalent acid aluminum salt increases, the polishing removal rate is further improved, and the thickness unevenness of the object to be polished after polishing can be reduced. In addition, the concentration (content) of the monovalent acid aluminum salt is preferably 25% by mass or less, more preferably 20% by mass or less, still more preferably 18% by mass or less, further preferably 15% by mass or less, particularly preferably 12% by mass or less, and most preferably 10% by mass or less with respect to the total mass of the polishing composition. Within the above range, the polishing removal rate of the resin material can be further improved, and the thickness unevenness of the object to be polished after polishing can be reduced. One preferable example of the concentration (content) of the monovalent acid aluminum salt is preferably 0.1% by mass or more and 25% by mass or less, more preferably 0.5% by mass or more and 20% by mass or less, still more preferably 1% by mass or more and 18% by mass or less, further preferably 2% by mass or more and 15% by mass or less, particularly preferably 3% by mass or more and 12% by mass or less, and most preferably 5% by mass or more and 10% by mass or less with respect to the total mass of the polishing composition. The monovalent acid aluminum salt may be used alone or in combination of two or more types thereof. When two or more types of monovalent acid aluminum salts are used, the concentration (content) of the monovalent acid aluminum salt is taken as the total amount.

Examples of the pyrrolidone compound include 2-pyrrolidone or a 2-pyrrolidone derivative, and a polymer having a structural unit derived from a 2-pyrrolidone derivative. Examples of the 2-pyrrolidone derivative include 2-pyrrolidone, N-octyl-2 pyrrolidone, N-dodecyl-2 pyrrolidone, N-methyl-2 pyrrolidone, N-ethyl-2 pyrrolidone, N-cyclohexyl-2 pyrrolidone, N-hydroxyethyl-2 pyrrolidone, N-butyl-2-pyrrolidone, N-hexyl-2-pyrrolidone, N-decyl-2-pyrrolidone, N-octadecyl-2-pyrrolidone, N-hexadecyl-2-pyrrolidone, and N-vinyl-2-pyrrolidone. Examples of the polymer having a structural unit derived from a 2-pyrrolidone derivative include a homopolymer (hereinafter also referred to as “polyvinylpyrrolidone” or “PVP”) or a copolymer of N-vinyl-2 pyrrolidone. These pyrrolidone compounds may be used alone or in combination of two or more types thereof. Among them, polyvinylpyrrolidone is preferable as the pyrrolidone compound.

The concentration (content) of the pyrrolidone compound in the polishing composition is not particularly limited, but is preferably 0.001% by mass or more, more preferably 0.003% by mass or more, still more preferably 0.005% by mass or more, further preferably 0.007% by mass or more, particularly preferably 0.008% by mass or more, and most preferably 0.01% by mass or more with respect to the total mass of the polishing composition. As the concentration of the pyrrolidone compound increases, the polishing removal rate is further improved, and the thickness unevenness of the object to be polished after polishing can be reduced. In addition, the concentration (content) of the pyrrolidone compound is preferably 3% by mass or less, more preferably 2% by mass or less, still more preferably 1.5% by mass or less, further preferably 1.2% by mass or less, particularly preferably 1% by mass or less, and most preferably 0.5% by mass or less with respect to the total mass of the polishing composition. Within the above range, the polishing removal rate of the resin material can be further improved, and the thickness unevenness of the object to be polished after polishing can be reduced. One preferable example of the concentration (content) of the pyrrolidone compound is preferably 0.001% by mass or more and 3% by mass or less, more preferably 0.003% by mass or more and 2% by mass or less, still more preferably 0.005% by mass or more and 1.5% by mass or less, further preferably 0.007% by mass or more and 1.2% by mass or less, particularly preferably 0.008% by mass or more and 1% by mass or less, and most preferably 0.01% by mass or more and 0.5% by mass or less with respect to the total mass of the polishing composition. When two or more types of pyrrolidone compounds are used, the concentration (content) of the pyrrolidone compounds is taken as the total amount.

In the polishing composition of the second aspect, according to one embodiment, the pyrrolidone compound is polyvinylpyrrolidone. In this case, the weight average molecular weight (Mw) of polyvinylpyrrolidone is preferably 2,000 or more, more preferably 3,000 or more, still more preferably 5,000 or more, and particularly preferably 7,500 or more. In addition, the weight average molecular weight (Mw) of polyvinylpyrrolidone is preferably 900,000 or less, more preferably 500,000 or less, still more preferably 250,000 or less, particularly preferably 100,000 or less, and most preferably 55,000 or less. When the weight average molecular weight is polyvinylpyrrolidone within the above range, it is possible to more efficiently improve the polishing removal rate of the resin material and reduce the thickness unevenness of the object to be polished after polishing.

Examples of the caprolactam compound include F-caprolactam or a derivative thereof, and a polymer having a structural unit derived from F-caprolactam or a derivative thereof. The caprolactam compound can be used as an alternative to the pyrrolidone compound. Examples of the caprolactam compound include F-caprolactam and nylon 6.

The concentration (content) of the caprolactam compound in the polishing composition is not particularly limited, but is preferably 0.01% by mass or more, more preferably 0.05% by mass or more, and still more preferably 0.1% by mass or more with respect to the total mass of the polishing composition. In addition, the concentration (content) of the caprolactam compound is preferably 5% by mass or less, more preferably 2% by mass or less, and still more preferably 1% by mass or less. When the content of the caprolactam compound is within the above range, it is possible to more efficiently improve the polishing removal rate of the resin material and reduce the thickness unevenness of the object to be polished after polishing.

The pyrrolidone compound and the caprolactam compound may be commercially available products or may be synthesized by a known method.

According to one embodiment, in the polishing composition of the second aspect, the polishing accelerator contains a monovalent acid aluminum salt and a pyrrolidone compound. When the polishing composition according to the second aspect contains a monovalent acid aluminum salt and a pyrrolidone compound as polishing accelerators, it is possible to more efficiently improve the polishing removal rate of the resin material and reduce the thickness unevenness of the object to be polished after polishing.

### [Water]

The polishing composition according to the second aspect contains water. The water disperses or dissolves each component. From the viewpoint of preventing the influence of impurities on other components of the polishing composition, it is preferable to use water having as high purity as possible. Specifically, pure water, ultrapure water, or distilled water from which impurity ions are removed with an ion exchange resin and then foreign substances are removed through a filter is more preferable. In addition, for the purpose of controlling the dispersibility or the like of other components in the polishing composition, an organic solvent or the like as a dispersing medium may be further included.

The main components contained in the polishing composition according to the first aspect and the polishing composition according to the second aspect are as described above. The following “other components” are commonly applied to the polishing composition according to the first aspect and the polishing composition according to the second aspect.

### [Other Components]

The polishing composition according to the present aspect may further contain known components (hereinafter “other components”) such as a pH adjusting agent, a surfactant, a dispersant, a thickener (viscosity adjusting agent), a surface protecting agent, a wetting agent, a water-soluble polymer (here, a polymer having a structural unit derived from 2-pyrrolidone is excluded), a salt (here, monovalent acid aluminum salts are excluded), an antiseptic agent, and an antifungal agent as long as the effects of the present invention are not impaired. The content of these other components may be appropriately set according to the purpose of addition. Hereinafter, pH adjusting agents, surfactants, dispersants, thickeners (viscosity adjusting agents), oxidizing agents, anticorrosive agents, antiseptic agents, antifungal agents, and chelating agents will be described.

### <pH Adjusting Agent>

The polishing composition according to the present aspect may further contain a pH adjusting agent. The pH adjusting agent can contribute to the adjustment of the pH of the polishing composition by selecting the type and addition amount thereof.

The pH adjusting agent is not particularly limited as long as the pH adjusting agent is a compound having a pH adjusting function, and a known compound can be used. The pH adjusting agent is not particularly limited as long as the pH adjusting agent has a pH adjusting function, and examples thereof include an acid and an alkali.

As the acid, either an inorganic acid or an organic acid may be used. The inorganic acid is not particularly limited, and examples thereof include sulfuric acid, nitric acid, hydrochloric acid, boric acid, carbonic acid, hypophosphorous acid, phosphorous acid, and phosphoric acid. Specific examples of the organic acid is not particularly limited, and examples thereof include carboxylic acids such as formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, and lactic acid; methanesulfonic acid; ethanesulfonic acid; and isethionic acid. Among them, an organic acid is preferable, and malic acid, citric acid, and maleic acid are more preferable. When an inorganic acid is used, nitric acid, sulfuric acid, or phosphoric acid is preferable.

The alkali is not particularly limited, and examples thereof include a hydroxide of an alkali metal, a salt of an alkali metal, a hydroxide of an alkaline earth metal, a salt of an alkaline earth metal, quaternary ammonium, and ammonia.

Specific examples of the alkali metal include potassium and sodium. In addition, specific examples of the alkaline earth metal include calcium and strontium. Further, examples of the salt include a carbonate, a hydrogen carbonate, a sulfate, and an acetate. Furthermore, specific examples of the quaternary ammonium include tetramethylammonium, tetraethylammonium, tetrabutylammonium, and hydroxides thereof. Among them, potassium hydroxide or ammonia is preferable as the alkali.

In addition, the pH adjusting agent may be used alone or in combination of two or more types thereof.

The pH of the polishing composition according to the present aspect is not particularly limited, but is preferably 8 or less, more preferably 7 or less, still more preferably 6 or less, particularly preferably 5 or less, and most preferably 4 or less. According to an embodiment, the pH of the polishing composition according to the present aspect may be 3.5 or less, 3 or less, or less than 3. When the pH of the polishing composition is within the above range, it is possible to more efficiently improve the polishing removal rate of the resin material and reduce the thickness unevenness of the object to be polished after polishing. In addition, the pH is preferably 1 or more, and more preferably 1.5 or more. As an example, the pH of the polishing composition is preferably 1 or more and 8 or less, more preferably 1 or more and 7 or less, still more preferably 1 or more and 6 or less, particularly preferably 1 or more and 5 or less, and most preferably 1 or more and 4 or less. According to one embodiment, the pH of the polishing composition is 1.0 or more and 6.0 or less, 1.0 or more and 5.0 or less, 1.5 or more and 4.5 or less, 1.5 or more and 4.0 or less, 2.0 or more and 5.0 or less, 2.0 or more and 4.5 or less, 2.0 or more and 4.0 or less, or 1.0 or more and 3.5 or less. The content of the pH adjusting agent is not particularly limited, and is preferably an amount that can set the pH value to a value within the above preferable range.

### <Surfactant>

The polishing composition according to some embodiments of the present invention may contain a surfactant. The surfactant that can be contained in the polishing composition of the present aspect is at least one selected from the group consisting of an anionic surfactant, a cationic surfactant, an amphoteric surfactant, and a nonionic surfactant. Among them, a nonionic surfactant is preferable as the surfactant contained in the polishing composition. These surfactants may be used alone or in combination of two or more types thereof.

Examples of the anionic surfactant include polyoxyethylene alkyl ether acetic acid, polyoxyethylene alkyl sulfuric acid ester, alkyl sulfuric acid ester, polyoxyethylene alkyl ether sulfuric acid, alkyl ether sulfuric acid, alkyl benzene sulfonic acid, alkyl phosphoric acid ester, polyoxyethylene alkyl phosphoric acid ester, polyoxyethylene sulfosuccinic acid, alkyl sulfosuccinic acid, alkyl naphthalene sulfonic acid, alkyl diphenyl ether disulfonic acid, and salts thereof.

Examples of the cationic surfactant include an alkyltrimethylammonium salt, an alkyldimethylammonium salt, an alkylbenzyldimethylammonium salt, and an alkylamine salt.

Examples of the amphoteric surfactant include alkyl betaine and alkylamine oxide.

Examples of the nonionic surfactant include polyoxyalkylene alkyl ethers such as polyoxyethylene alkyl ethers, sorbitan fatty acid esters, glycerin fatty acid esters, polyoxyethylene fatty acid esters, polyoxyethylene alkylamines, and alkylalkanolamides.

When the polishing composition contains a surfactant, the content of the surfactant is preferably 0.01% by mass or more, and more preferably 0.1% by mass or more with respect to the total mass of the polishing composition. In addition, the content of the surfactant in the polishing composition is preferably 3.0% by mass or less, and more preferably 2.0% by mass or less with respect to the total mass of the polishing composition. When the content of the surfactant is within the above range, the uniformity of polishing of the object to be polished is further improved.

### <Dispersant/Thickener (Viscosity Adjusting Agent)>

The polishing composition according to the present aspect may contain a dispersant or a thickener (viscosity adjusting agent). The dispersant or thickener plays a role of uniformly dispersing the abrasive grains (silica particles) in the liquid, thereby enabling the abrasive grains to efficiently act on the object to be polished. In addition, since the dispersant or thickener is present between the abrasive grains, an action of suppressing caking of the abrasive grains can also be expected, and accordingly, generation of scratches caused by the aggregated abrasive grains is suppressed.

Specific examples of the dispersant include colloidal substances as substances containing fine particles, such as colloidal alumina, colloidal zirconia, colloidal titania, alumina sol, zirconia sol, titania sol, fumed alumina, fumed zirconia, and fumed titania. In addition, sodium phosphate, sodium hexametaphosphate, sodium pyrophosphate, and the like, which are generally used as a dispersant, may be used.

Specific examples of the thickener include glycols such as a propylene glycol polymer and an ethylene glycol polymer, and polymer compounds. More specific examples of the glycols include propylene glycol, ethylene glycol, dipropylene glycol, polypropylene glycol, diethylene glycol, and polyethylene glycol. Examples of the polymer compound include sodium polyacrylate, polyvinyl alcohol, and hydroxyethyl cellulose.

### [Polishing Removal Rate]

The polishing composition according to the present aspect can improve the polishing removal rate of the resin material. As an example, the polishing removal rate of the resin material is preferably 140 nm/min or more, more preferably 150 nm/min or more, and still more preferably 170 nm/min or more. In addition, the polishing removal rate can be measured by the method described in Examples.

### [Thickness Unevenness]

The polishing composition according to the present aspect can maintain or improve the flatness of the object to be polished. That is, the polishing composition according to the present aspect can reduce the thickness unevenness of the object to be polished which may be caused by polishing. The thickness unevenness can be evaluated using GBIR. As an example, the thickness unevenness of the object to be polished after polishing (polished object to be polished) by the polishing composition of the present aspect is preferably less than 2.0 μm, more preferably 1.5 m or less, still more preferably 1.2 μm or less, and particularly preferably 0.8 μm or less. Therefore, in one embodiment, according to the polishing composition of the present aspect, the flatness defined by GBIR of the polished object to be polished can be less than 2.0 μm (preferably 1.5 m or less, more preferably 1.2 μm or less, and still more preferably 0.8 μm or less). In addition, the GBIR can be measured by the method described in Examples.

### [Surface Roughness (Rms)]

The polishing composition according to the present aspect can maintain or improve the surface roughness of the object to be polished. In other words, the polishing composition according to the present aspect can reduce the surface roughness of the object to be polished that may occur due to polishing. The surface roughness of the object to be polished can be evaluated using the root mean square height (Rms), a parameter that evaluates the variation in unevenness relative to a reference surface. For example, the root mean square height (Rms) of the object to be polished after polishing (polished object to be polished) with the polishing composition according to the present aspect is preferably less than 1.5 nm, more preferably 1.2 nm or less, even more preferably 1.0 nm or less, particularly preferably 0.8 nm or less, and most preferably 0.5 nm or less. The lower limit of the surface roughness defined by the root mean square height (Rms) of the polished object to be polished is not particularly limited, but in practice, it is, for example, 0.01 nm or more. Therefore, in one embodiment, the surface roughness defined by the root mean square height (Rms) of the polished object can be 1.0 nm or less (preferably 0.5 nm or less) according to the polishing composition according to the present aspect. The root mean square height (Rms) can be measured by the method described in the examples.

### [Method for Manufacturing Polishing Composition]

In the polishing composition according to the present aspect, the method (preparation method) for manufacturing the polishing composition is not particularly limited, and for example, the method may be a method including stirring and mixing silica particles; a polishing accelerator (one or more selected from the group consisting of a monovalent acid aluminum salt, a pyrrolidone compound, and a caprolactam compound); and if necessary, other components, can be appropriately adopted. Since the silica particles, water, the polishing accelerator, and other components are the same as those described above, the description thereof is omitted here.

In the polishing composition, the temperature at which each component is mixed is not particularly limited, but is preferably 10° C. or more and 40° C. or less, and heating may be performed in order to increase the rate of dissolution. The mixing time is also not particularly limited.

### [Polishing Method]

Another aspect of the present invention relates to a polishing method including a step of polishing an object to be polished containing a resin material, using the above-described polishing composition. The polishing step is not limited to one performed after the lapping step, and may be performed after the cutting step or the grinding step. Preferable examples of the object to be polished in the polishing method according to the present aspect are the same as those mentioned in the description of [Object to be Polished].

A third aspect of the present invention is a polishing method, including polishing an object to be polished containing a resin material with the polishing composition according to the first aspect. Therefore, according to a third aspect of the present invention, there is provided a polishing method including a step of supplying a polishing composition between an object to be polished containing a resin material and a polishing pad to polish the object, wherein the polishing composition contains silica and water, and the silica particle has a secondary particle size D₅₀ of 50 nm or more.

A fourth aspect of the present invention is a polishing method, including polishing an object to be polished containing a resin material with the polishing composition according to the second aspect. Therefore, according to a fourth aspect of the present invention, there is provided a polishing method including a step of supplying a polishing composition between an object to be polished containing a resin material and a polishing pad to polish the object, wherein the polishing composition contains a silica particle, a polishing accelerator, and water, the polishing accelerator is one or more selected from the group consisting of a monovalent acid aluminum salt, a pyrrolidone compound, and a caprolactam compound, and in the silica particles, a shape irregularity N represented by the shape irregularity N=SA/SA′ is 1.5 or more, when a particle size at which a cumulative frequency from a small particle size side in a volume-based particle size distribution is 50% is defined as D₅₀, a BET specific surface area is defined as SA, and a theoretical specific surface area calculated from the D₅₀ is defined as SA′.

In the polishing method according to the present aspect, when the object to be polished is polished using the polishing composition, the polishing can be performed using an apparatus or conditions used for normal polishing. Examples of a general polishing apparatus include a single-side polishing apparatus and a double-side polishing apparatus. In a single-side polishing apparatus, an object to be polished is generally held using a holding tool called a carrier, and while a polishing composition is supplied from above, a surface plate having a polishing pad attached to one side of the object to be polished is pressed to rotate the surface plate, thereby polishing one side of the object to be polished. In a double-side polishing apparatus, generally, an object to be polished is held using a holding tool called a carrier, a surface plate to which a polishing pad is attached is pressed against a facing surface of the object to be polished while a polishing composition is supplied from above, and both surfaces of the object to be polished are polished by rotating these in relative directions. At this time, polishing is performed by a physical action caused by friction between the polishing pad and the polishing composition, and the object to be polished, and a chemical action caused by the polishing composition to the object to be polished. As the polishing pad, a porous body such as a nonwoven pad, a polyurethane pad, or a suede pad can be used without particular limitation. The polishing pad is preferably grooved such that a polishing liquid is accumulated.

Examples of the polishing conditions of the polishing method according to the present aspect include a polishing load, a table rotation speed, a carrier rotation speed, a flow rate of the polishing composition, and a polishing time. These polishing conditions are not particularly limited, but for example, the polishing load is preferably 0.1 psi (0.69 kPa) or more and 10 psi (69 kPa) or less, and more preferably 0.5 psi (3.5 kPa) or more and 5.0 psi (35 kPa) or less per unit area of the object to be polished. In general, as the load increases, the frictional force by the abrasive grains increases, and the mechanical processing force is improved, and thus the polishing removal rate increases. Within this range, a sufficient polishing removal rate is exhibited, and it is possible to suppress breakage of the object to be polished due to a load and occurrence of defects such as scratches on the surface. The supply amount of the polishing composition may be a supply amount (flow rate) at which the entire object to be polished is covered, and may be adjusted according to conditions such as the size of the object to be polished. The method for supplying the polishing composition to the polishing pad is not particularly limited, and for example, a method for continuously supplying the polishing composition by a pump or the like is adopted. In addition, the processing time is not particularly limited as long as a desired processing result can be obtained, but it is preferable to set the processing time to a shorter time due to a high polishing removal rate.

Here, the surface of the object to be polished is generally finished into a flat surface with less thickness unevenness and a smooth surface with fewer defects through the lapping step and the polishing step. The polishing step includes one or more types of polishing steps selected from the group consisting of a rough polishing step (preliminary polishing step), a middle polishing step (intermediate polishing step), and fine polishing (finish polishing step). That is, the polishing step can include a plurality of polishing steps. The polishing method according to the present aspect using the above-described polishing composition can be suitably used in the middle polishing step and the fine polishing step, and particularly suitably used in the fine polishing step. The polishing method (that is, fine polishing) according to the present aspect may be performed, for example, after the rough polishing step and the middle polishing step, or may be performed after the rough polishing step by omitting the middle polishing step.

In each polishing step of the rough polishing step, the middle polishing step, and the fine polishing step, polishing characteristics required for each polishing step are different. Therefore, depending on the stage of the polishing step (that is, any one of the rough polishing step, the middle polishing step, and the fine polishing step), different configurations of the polishing composition (for example, the type of abrasive grains, the type of components such as the particle size of abrasive grains, the content of components, and the like); polishing conditions (for example, a polishing pad, a polishing pressure, a use amount (flow rate) of a polishing composition, and the like); and other factors may be employed.

In one embodiment, in the rough polishing step, it is preferable to polish the object to be polished with a double-side polishing apparatus that simultaneously polishes both surfaces of the substrate from the viewpoint of reducing thickness unevenness. In one embodiment, in the rough polishing step, as the polishing pad, a nonwoven fabric pad, a polyurethane pad, and a suede pad are preferable, a nonwoven fabric pad and a polyurethane pad are particularly preferable, and a polyurethane pad is most preferable from the viewpoint of reducing thickness unevenness.

According to one embodiment, the polishing load in the rough polishing step is preferably 0.1 psi (0.69 kPa) or more and 10 psi (69 kPa) or less, and more preferably 0.5 psi (3.5 kPa) or more and 5.0 psi (35 kPa) or less per unit area of the object to be polished. According to one embodiment, the supply amount of the polishing composition (also referred to as a flow rate of the polishing composition or a slurry flow rate) in the rough polishing step is not particularly limited, but is preferably, for example, 1 (mL/min) or more and 300 (mL/min) or less, 1 (mL/min) or more and 200 (mL/min) or less, 1 (mL/min) or more and 150 (mL/min) or less, 1 (mL/min) or more and 100 (mL/min) or less, or 1 (mL/min) or more and 50 (mL/min) or less.

In one embodiment, in the rough polishing step, the Shore A hardness of the polishing pad is preferably 98° or less, more preferably 950 or less. The lower limit of the Shore A hardness of the polishing pad in the rough polishing step is preferably 600 or more, more preferably 700 or more, still more preferably 80° or more. According to one embodiment, the Shore A hardness of the polishing pad may be 600 or more and 98° or less, 700 or more and 980 or less, 700 or more and 950 or less, 80° or more and 98° or less, or 80° or more and 950 or less. When the Shore A hardness of the polishing pad used in the rough polishing step is within the above range, the polishing pad and the object to be polished are in contact with each other at an appropriate pressure, and the effects of improving the polishing removal rate of the resin material and reducing the thickness unevenness of the object to be polished after polishing are further exhibited. The Shore A hardness of the polishing pad is a value measured based on a type A durometer in accordance with JIS K 6253-3:2012.

According to one embodiment, in the manufacturing method according to the present aspect, the object to be polished may be subjected to polishing with a polishing composition containing alumina particles as abrasive grains in the rough polishing step. In this case, the average primary particle size D₅₀ of the alumina particles is preferably 0.1 μm or more and 5.0 μm or less.

According to one embodiment, by the rough polishing step, an object to be polished after polishing (object to be polished after rough polishing) having a thickness of preferably 0.10 mm or more and 0.80 mm or less, more preferably 0.10 mm or more and 0.60 mm or less, and still more preferably 0.10 mm or more and 0.55 mm or less can be obtained. In addition, according to one embodiment, by the rough polishing step, an object to be polished after polishing (object to be polished after rough polishing) having a surface having a GBIR of preferably 1.5 μm or less, more preferably 1.0 μm or less, and still more preferably less than 0.5 μm can be obtained. According to one embodiment, by the rough polishing step, an object to be polished after rough polishing having a surface in which a defect with a depth of 100 nm or more remains can be obtained.

In one embodiment, a middle step is performed after the rough step. In the middle polishing step, it is preferable to polish the object to be polished with a double-side polishing apparatus that simultaneously polishes both surfaces of the substrate from the viewpoint of reducing thickness unevenness. In one embodiment, in the middle polishing step, as the polishing pad, a nonwoven fabric pad, a polyurethane pad, and a suede pad are preferable, a nonwoven fabric pad and a polyurethane pad are particularly preferable, and a polyurethane pad is most preferable from the viewpoint of reducing thickness unevenness.

According to one embodiment, the polishing load in the middle polishing step is preferably 0.1 psi (0.69 kPa) or more and 10 psi (69 kPa) or less, and more preferably 0.5 psi (3.5 kPa) or more and 5.0 psi (35 kPa) or less per unit area of the object to be polished. According to one embodiment, the supply amount of the polishing composition in the middle polishing step is not particularly limited, but is preferably, for example, 1 (mL/min) or more and 300 (mL/min) or less, 1 (mL/min) or more and 200 (mL/min) or less, 1 (mL/min) or more and 150 (mL/min) or less, 1 (mL/min) or more and 100 (mL/min) or less, or 1 (mL/min) or more and 50 (mL/min) or less.

According to one embodiment, in the manufacturing method according to the present aspect, the object to be polished may be subjected to polishing with the polishing composition in the middle polishing step.

In one embodiment, in the middle polishing step, the Shore A hardness of the polishing pad is preferably 900 or less, more preferably 850 or less, still more preferably 820 or less, still more preferably 800 or less, particularly preferably 780 or less, and most preferably 750 or less. The lower limit of the Shore A hardness of the polishing pad in the middle polishing step is preferably 10° or more, more preferably 20° or more, still more preferably 30° or more, particularly preferably 400 or more, and most preferably 500 or more. According to one embodiment, the Shore A hardness of the polishing pad may be 600 or more and 80° or less, 650 or more and 80° or less, or 680 or more and 800 or less. When the Shore A hardness of the polishing pad used in the middle polishing step is within the above range, the polishing pad and the object to be polished are in contact with each other at an appropriate pressure, and the effects of improving the polishing removal rate of the resin material and reducing the thickness unevenness of the object to be polished after polishing are further exhibited. The Shore A hardness of the polishing pad is a value measured based on a type A durometer in accordance with JIS K 6253-3:2012.

According to one embodiment, by the middle polishing step, an object to be polished after polishing (object to be polished after middle polishing) having a thickness of preferably 0.10 mm or more and 0.80 mm or less, more preferably 0.10 mm or more and 0.60 mm or less, and still more preferably 0.10 mm or more and 0.55 mm or less can be obtained. In addition, according to one embodiment, by the middle polishing step, an object to be polished after polishing (object to be polished after middle polishing) having a surface having a GBIR of preferably 1.5 μm or less, more preferably 1.0 μm or less, and still more preferably less than 0.5 μm can be obtained. According to one embodiment, by the middle polishing step, an object to be polished after polishing having a surface in which a defect with a depth of 70 nm or less remains can be obtained. That is, according to the polishing method according to the present aspect, it is possible to reduce defects of the object to be polished and to obtain a polished object to be polished (object to be polished after polishing) in which scratches with a depth of less than 100 nm are also reduced.

By performing the fine polishing step using the polishing composition after the rough polishing step, or the rough polishing step and the middle polishing step, it is possible to obtain an object to be polished in which the resin material is polished at high speed and thickness unevenness is suppressed. Therefore, according to one embodiment, according to the manufacturing method of the present aspect, the object to be polished including the resin material is subjected to the rough polishing step, or the rough polishing step and the middle polishing step.

In one embodiment, in the fine polishing step, it is preferable to polish the object to be polished with a double-side polishing apparatus that simultaneously polishes both surfaces of the substrate from the viewpoint of reducing thickness unevenness. In one embodiment, in the fine polishing step, a polyurethane pad or a suede pad is preferably used as the polishing pad, and a suede pad is more preferably used.

In one embodiment, in the fine polishing step, the Shore A hardness of the polishing pad is preferably 900 or less, more preferably 85° or less, still more preferably 82° or less, still more preferably 80° or less, particularly preferably 78° or less, and most preferably 750 or less. The lower limit of the Shore A hardness of the polishing pad is preferably 10° or more, more preferably 20° or more, still more preferably 300 or more, particularly preferably 400 or more, more particularly preferably 450 or more, and most preferably 500 or more. According to one embodiment, the Shore A hardness of the polishing pad may be 450 or more and 800 or less, 500 or more and 800 or less, 600 or more and 800 or less, 650 or more and 800 or less, or 680 or more and 800 or less. When the Shore A hardness of the polishing pad used in the fine polishing step is within the above range, the polishing pad and the object to be polished are in contact with each other at an appropriate pressure, and the effects of improving the polishing removal rate of the resin material and reducing the thickness unevenness of the object to be polished after polishing are further exhibited.

According to one embodiment, the polishing load in the fine polishing step is preferably 0.1 psi (0.69 kPa) or more and 10 psi (69 kPa) or less, and more preferably 0.5 psi (3.5 kPa) or more and 5.0 psi (35 kPa) or less per unit area of the object to be polished. According to one embodiment, the supply amount of the polishing composition in the fine polishing step is preferably 1 (mL/min) or more and 50 (mL/min) or less, more preferably 3 (mL/min) or more and 45 (mL/min) or less, still more preferably 5 (mL/min) or more and 40 (mL/min) or less, and particularly preferably 8 (mL/min) or more and 30 (mL/min) or less. When the supply amount of the polishing composition in the fine polishing step is within the above range, the thickness unevenness can be reduced. As the supply amount of the polishing composition is smaller, the thickness unevenness is improved, and the cost can be reduced from the viewpoint of the use amount of the polishing composition, which is preferable.

According to one embodiment, by the fine polishing step, an object to be polished after polishing (object to be polished after fine polishing) having a thickness of, for example 0.10 mm or more and 0.90 mm or less, preferably 0.10 mm or more and 0.80 mm or less, more preferably 0.10 mm or more and 0.60 mm or less, and still more preferably 0.10 mm or more and 0.55 mm or less can be obtained. In addition, according to one embodiment, by the fine polishing step, an object to be polished after polishing (object to be polished after fine polishing) having a surface having a GBIR of preferably 1.5 μm or less, more preferably 1.0 μm or less, and still more preferably less than 0.5 μm can be obtained. According to one embodiment, by the fine polishing step, an object to be polished after polishing having a surface in which a defect with a depth of 70 nm or less remains can be obtained. That is, according to the polishing method according to the present aspect, it is possible to reduce defects of the object to be polished and to obtain a polished object to be polished (object to be polished after polishing) in which scratches with a depth of less than 100 nm are also reduced.

In addition, still another aspect of the present invention relates to a method for manufacturing a polished object to be polished, including a step of polishing the object to be polished by the above-described polishing method. Preferable examples of the object to be polished according to the present aspect are the same as those mentioned in the description of [Object to be Polished]. A preferable example is a method for manufacturing an optical member, which includes a step of polishing an optical resin material by the above-mentioned polishing method.

### [Polishing System]

Still another aspect of the present invention relates to a polishing system including the above polishing composition, an object to be polished containing a resin material, and a polishing pad.

A fifth aspect of the present invention is a polishing system, including the polishing composition according to the first aspect, an object to be polished containing a resin material, and a polishing pad. Therefore, according to a fifth aspect of the present invention, there is provided a polishing system including an object to be polished containing a resin material, a polishing pad, and a polishing composition, wherein the polishing composition contains a silica particle, and water; and the silica particle has a secondary particle size D₅₀ of 50 nm or more; and a surface of the object to be polished is brought into contact with the polishing pad and the polishing composition.

A sixth aspect of the present invention is a polishing system, including the polishing composition according to the second aspect, an object to be polished containing a resin material, and a polishing pad. Therefore, according to a sixth aspect of the present invention, there is provided a polishing system including an object to be polished containing a resin material, a polishing pad, and a polishing composition, wherein the polishing composition contains a silica particle, a polishing accelerator, and water; the polishing accelerator is one or more selected from the group consisting of a monovalent acid aluminum salt, a pyrrolidone compound, and a caprolactam compound; and in the silica particles, a shape irregularity N represented by the shape irregularity N=SA/SA′ is 1.5 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′; and a surface of the object to be polished is brought into contact with the polishing pad and the polishing composition.

Preferable embodiments of the object to be polished and the polishing composition applied to the polishing system of the present aspect are the same as those described above, and thus the description thereof will be omitted.

In the polishing system of the present aspect, both surfaces of the object to be polished may be simultaneously polished by bringing both surfaces of the object to be polished into contact with the polishing pad and the polishing composition, or only one surface of the object to be polished may be polished by bringing only one surface of the object to be polished into contact with the polishing pad and the polishing composition.

In the polishing system of the present aspect, a working slurry containing the polishing composition is prepared. Next, the polishing composition is supplied to the object to be polished and polished by a conventional method. For example, an object to be polished is set in a general polishing apparatus, and a polishing composition is supplied to a surface (surface to be polished) of the object to be polished through a polishing pad of the polishing apparatus. Typically, while continuously supplying the polishing composition, the polishing pad is pressed against the surface of the object to be polished to relatively move (for example, rotationally move) both of them. Polishing of the object to be polished is completed through such a polishing step.

The polishing pad used in the polishing system of the present aspect may be a nonwoven pad, a polyurethane pad, or a suede pad. Among them, the polishing pad is preferably a polyurethane pad or a suede pad, and is more preferably a suede pad from the viewpoint of further reducing defects.

In the polishing system of the present aspect, the pressure at the time of coming into contact with the polishing pad and the polishing composition, that is, the polishing load is preferably 0.1 psi (0.69 kPa) or more and 10 psi (69 kPa) or less, and more preferably 0.5 psi (3.5 kPa) or more and 5.0 psi (35 kPa) or less per unit area of the object to be polished. According to one embodiment, the supply amount of the polishing composition in the polishing system of the present aspect is preferably 1 (mL/min) or more and 50 (mL/min) or less, more preferably 3 (mL/min) or more and 45 (mL/min) or less, still more preferably 5 (mL/min) or more and 40 (mL/min) or less, and particularly preferably 8 (mL/min) or more and 30 (mL/min) or less.

In the polishing system of the present aspect, according to one embodiment, the Shore A hardness of the polishing pad is preferably 900 or less, more preferably 850 or less, still more preferably 82° or less, still more preferably 80° or less, particularly preferably 780 or less, and most preferably 750 or less. The lower limit of the Shore A hardness of the polishing pad is preferably 100 or more, more preferably 200 or more, still more preferably 300 or more, particularly preferably 400 or more, more particularly preferably 450 or more, and most preferably 500 or more. According to one embodiment, the Shore A hardness of the polishing pad may be 450 or more and 800 or less, 500 or more and 800 or less, 600 or more and 800 or less, 650 or more and 800 or less, or 680 or more and 800 or less. In the polishing system of the present aspect, when the Shore A hardness of the polishing pad is within the above range, the polishing pad and the object to be polished are in contact with each other at an appropriate pressure, and the effects of improving the polishing removal rate of the resin material and reducing the thickness unevenness of the object to be polished after polishing are further exhibited.

Although the embodiments of the present invention have been described in detail, this is illustrative and exemplary and not restrictive, and it is clear that the scope of the present invention should be interpreted by the appended claims.

The present invention includes the following aspects and forms.
[1]A polishing composition used for polishing an object to be polished comprising a resin material, wherein a silica particle, and water are comprised, and the silica particle has a secondary particle size D₅₀ of 50 nm or more.
[2] The polishing composition according to above [1], further comprising a polishing accelerator, and the polishing accelerator is one or more selected from the group consisting of a monovalent acid aluminum salt, a pyrrolidone compound, and a caprolactam compound.
[3] The polishing composition according to above [1] or [2], wherein in the silica particles, a shape irregularity N represented by the shape irregularity N=SA/SA′ is 1.2 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′.
[4] The polishing composition according to any one of above [1] to [3], wherein the silica particle has a secondary particle size D₅₀ of 50 nm or more and less than 200 nm.
[5] The polishing composition according to any one of above [1] to [4], wherein the polishing accelerator comprises the monovalent acid aluminum salt and the pyrrolidone compound.
[6] The polishing composition according to any one of above [1] to [5], wherein in the silica particles, a ratio of D₉₀ to D₁₀ (D₉₀/D₁₀) is 2.0 or more, when a particle size at which a cumulative frequency from a small particle size side in a volume-based particle size distribution of the silica particles is 10% is defined as D₁₀, and a particle size at which a cumulative frequency from a small particle size side in a volume-based particle size distribution of the silica particles is 90% is defined as D₉₀.
[7] The polishing composition according to any one of above [1] to [6], wherein the resin material is an optical resin material.
[8] The polishing composition according to any one of above [1] to [7], wherein an average thickness of the object to be polished before polishing is 1 mm or less.
[9] The polishing composition according to any one of above [1] to [8], wherein flatness defined by GBIR of the object to be polished after polishing is 1.5 μm or less.
[10]A polishing composition used for polishing an object to be polished comprising a resin material, wherein a silica particle, a polishing accelerator, and water are comprised, the polishing accelerator is one or more selected from the group consisting of a monovalent acid aluminum salt, a pyrrolidone compound, and a caprolactam compound, and in the silica particles, a shape irregularity N represented by the shape irregularity N=SA/SA′ is 1.5 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′.
[11]A polishing method comprising: a step of polishing an object to be polished containing a resin material, using the polishing composition according to any one of above [1] to [10].
[12]A method for manufacturing an optical member, the method comprising: a step of polishing an optical resin material by the polishing method according to above [11].
[13]A polishing method comprising supplying a polishing composition between an object to be polished comprising a resin material and a polishing pad to polish the object, wherein the polishing composition comprises silica and water, and the silica particle has a secondary particle size D₅₀ of 50 nm or more.
[14] The polishing method according to above [13], wherein the polishing pad has a Shore A hardness of 40 or more.
[15] The polishing method according to above [13] or [14], wherein the polishing composition further comprising a polishing accelerator, and the polishing accelerator is one or more selected from the group consisting of a monovalent acid aluminum salt, a pyrrolidone compound, and a caprolactam compound.
[16] The polishing method according to any one of above [13] to [15], wherein in the silica particles, a shape irregularity N represented by the shape irregularity N=SA/SA′ is 1.2 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′.
[17] The polishing method according to any one of above [13] to [16], wherein the silica particle has a secondary particle size D₅₀ of 50 nm or more and less than 200 nm.
[18] The polishing method according to any one of above [13] to [17], wherein flatness defined by GBIR of the object to be polished after polishing is 1.5 μm or less.
[19]A polishing system comprising an object to be polished comprising a resin material, a polishing pad, and a polishing composition, wherein the polishing composition comprises a silica particle, and water; and the silica particle has a secondary particle size D₅₀ of 50 nm or more; and a surface of the object to be polished is brought into contact with the polishing pad and the polishing composition.
[20]A polishing system comprising an object to be polished comprising a resin material, a polishing pad, and a polishing composition, wherein the polishing composition comprises a silica particle, a polishing accelerator, and water; the polishing accelerator is one or more selected from the group consisting of a monovalent acid aluminum salt, a pyrrolidone compound, and a caprolactam compound; and in the silica particles, a shape irregularity N represented by the shape irregularity N=SA/SA′ is 1.5 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′; and a surface of the object to be polished is brought into contact with the polishing pad and the polishing composition.
[21] The polishing system according to above [19] or [20], wherein the polishing pad has a Shore A hardness of 40 or more.

The present invention includes also the following aspects and forms.
[1]A polishing composition used for polishing an object to be polished containing a resin material, in which a silica particle, a polishing accelerator, and water are contained, the polishing accelerator is one or more selected from the group consisting of a monovalent acid aluminum salt, a pyrrolidone compound, and a caprolactam compound, and in the silica particles, a shape irregularity N represented by the shape irregularity N=SA/SA′ is 1.5 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′.
[2] The polishing composition according to above [1], in which the polishing accelerator contains the monovalent acid aluminum salt and the pyrrolidone compound.
[3] The polishing composition according to above [1] or [2], in which in the silica particles, a ratio of D₉₀ to D₁₀ (D₉₀/D₁₀) is 2.0 or more, when a particle size at which a cumulative frequency from a small particle size side in a volume-based particle size distribution of the silica particles is 10% is defined as D₁₀, and a particle size at which a cumulative frequency from a small particle size side in a volume-based particle size distribution of the silica particles is 90% is defined as D₉₀.
[4] The polishing composition according to any one of above [1] to [3], in which the resin material is an optical resin material.
[5] The polishing composition according to any one of above [1] to [4], in which an average thickness of the object to be polished before polishing is 1 mm or less.
[6] The polishing composition according to any one of above [1] to [5], in which flatness defined by GBIR of the object to be polished after polishing is 1.5 μm or less.
[7]A polishing method including: a step of polishing an object to be polished containing a resin material, using the polishing composition according to any one of above [1] to [6].
[8]A method for manufacturing an optical member, the method including: a step of polishing an optical resin material by the polishing method according to above [7].
[9]A polishing system including an object to be polished containing a resin material, a polishing pad, and a polishing composition, in which the polishing composition contains a silica particle, a polishing accelerator, and water, the polishing accelerator is one or more selected from the group consisting of a monovalent acid aluminum salt, a pyrrolidone compound, and a caprolactam compound, and in the silica particles, a shape irregularity N represented by the shape irregularity N=SA/SA′ is 1.5 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′, and a surface of the object to be polished is brought into contact with the polishing pad and the polishing composition.
[10] The polishing system according to above [9], in which the polishing pad is a suede pad.

### EXAMPLES

Examples of the present invention will be described. However, the technical scope of the present invention is not limited only to the following examples. Unless otherwise specified, “%” and “part” mean “% by mass” and “part by mass”, respectively.

### Preparation of Polishing Compositions of Examples 1 to 17 and Comparative Examples 1 and 2

A polishing composition of Examples 1 to 3 and a Comparative Example 1 was prepared by mixing colloidal silica in an amount described in Table 1, and water in a remaining amount when the total mass of the composition was 100 (mixing temperature: approximately 25° C., mixing time: approximately 30 minutes). A polishing composition Examples 4 to 17 and a Comparative Example 2 was prepared by mixing colloidal silica in an amount described in Table 2, a polishing accelerator in an amount described in Table 1, and water in a remaining amount when the total mass of the composition was 100 (mixing temperature: approximately 25° C., mixing time: approximately 30 minutes). Incidentally, the content was set to 8% by mass in the case of containing aluminum nitrate as a polishing accelerator, and the content was set to 0.01% by mass in the case of containing polyvinylpyrrolidone. The weight average molecular weight of polyvinylpyrrolidone was 45,000.

The volume-based average primary particle size of the silica particles used as the abrasive grains and the pH of each polishing composition are as shown in Tables 1 and 2. In Tables 1 and 2, “-” indicates that the component is not contained.

For the polishing composition obtained as described above, the physical properties of silica particles were evaluated, and the polishing removal rate of an object to be polished (episulfide-based resin base material) and scratches on the surface of the object to be polished (episulfide-based resin substrate surface) were evaluated according to the method to be described later.

### [Evaluation]

<D₁₀, D₅₀, and D₉₀ of Silica Particles>

The silica particles were measured using a laser diffraction type particle size distribution measuring apparatus (Microtrac particle size distribution measuring apparatus MT3300EX II manufactured by MicrotracBEL Corp.) to obtain a volume-based particle size distribution. In the obtained particle size distribution, the particle size at which the cumulative frequency from the small particle size side was 10% was defined as D₁₀ of the silica particles, the particle size at which the cumulative frequency from the small particle size side was 50% was defined as D₅₀ of the silica particles, and the particle size at which the cumulative frequency from the small particle size side was 90% was defined as D₉₀ of the silica particles.

### <BET Specific Surface Area SA of Silica Particles>

The BET specific surface area SA of the silica particles was measured using a fully automatic specific surface area measuring apparatus (Macsorb (registered trademark) HM model-1201) manufactured by Mountech Co., Ltd.

### <Theoretical Specific Surface Area SA′ of Silica Particles>

The theoretical specific surface area SA′ of the silica particles was calculated by the following Formula (1) using the value of D₅₀ measured above.

$$\begin{matrix}[ Formula 2 ] & \\ Theoretical specific surface area SA ’ = \frac{6}{ρ \times {D}_{50}} & ( 1 )\end{matrix}$$

In the above Formula (1), ρ is the density of silica particles, and as shown in Tables 1 and 2, a value of 1.80 g/cm³ or 2.20 g/cm³ was used.

From the SA and SA′ obtained above, the shape irregularity N was calculated according to the equation: shape irregularity N=SA/SA′.

### <Evaluation of Polishing Removal Rate and Scratch>

A episulfide-based resin base material described below was prepared as an object to be polished, and (a) rough polishing, (b) middle polishing, and (c) fine polishing were sequentially performed. For the (a) rough polishing and the (b) middle polishing, polishing was performed under the polishing conditions described in the following steps using the polishing composition described in each of the following steps. When “none” is described in the middle polishing section in the following Tables 1 and 2, this indicates a system in which the (b) middle polishing is omitted, and the (c) fine polishing is performed after the (a) rough polishing is performed. In addition, GBIR and scratches of the object to be polished are evaluated in accordance with the criteria to be described later.

### [(a) Rough Polishing]

### (a1) Object to be Polished:

Episulfide-based resin base material: circular substrate having a diameter of 75 mm, thickness of 0.550 mm
Flatness (thickness unevenness) . . . GBIR of less than 0.5 m
Surface condition . . . Multiple lapping marks (depth of 100 to 1,500 nm)

### (a2) Polishing Composition:

A polishing composition (pH 3.2) containing 12.5% by mass of abrasive grains (alumina particles, particle size D₅₀:0.7 μm), 10% by mass of aluminum nitrate, and 0.5% by mass of PVP (water:the remainder when the total composition is 100% by mass) was used.

### (a3) Polishing Conditions:

Polishing apparatus: double-side polishing machine 6BN (Hamai Sangyo K.K.)
Surface plate diameter: 380 mm
Polishing pad: polyurethane pad (Shore D 43.0, Shore A 95) (product name: TYN13MP, manufactured by Fujibo Ehime Co., Ltd.)
Rotation speed of lower surface plate: 45 rpm
Rotation speed of upper surface plate: 0 rpm
Internal gear: 60%
Sun gear (normal rotation): 150%
Polishing pressure: 3.3 psi
Flow rate of polishing composition (slurry flow rate): 10 mL/min
Polishing time: 10 minutes

### [(b) Middle Polishing]

### (b1) Object to be Polished:

Object to be polished after rough polishing obtained through above (a) rough polishing (episulfide-based resin base material): circular substrate having a diameter of 75 mm, thickness of 0.502 mm
Flatness (thickness unevenness) . . . GBIR of less than 0.5 m
Surface condition . . . Scratch: C

### (b2) Polishing Composition:

A polishing composition (pH 3.2) containing 15% by mass of abrasive grains (colloidal silica, particle size D₅₀: 187 nm), 8% by mass of aluminum nitrate, and 0.1% by mass of PVP (water:the remainder when the total composition is 100% by mass) was used.

### (b3) Polishing Conditions:

Polishing apparatus: double-side polishing machine 6BN (Hamai Sangyo K.K.)
Surface plate diameter: 380 mm
Polishing pad: polyurethane pad (Shore D 43.0, Shore A 95) (product name: TYN13MP, manufactured by Fujibo Ehime Co., Ltd.)
Rotation speed of lower surface plate: 45 rpm
Rotation speed of upper surface plate: 0 rpm
Internal gear: 60%
Sun gear (normal rotation): 150%
Polishing pressure: 2.9 psi
Flow rate of polishing composition (slurry flow rate): 10 mL/min
Polishing time: 5 minutes

### [(c) Fine Polishing]

(c1-1) Object to be Polished:
Object to be polished after middle polishing obtained through above (b) middle polishing (episulfide-based resin base material): circular substrate having a diameter of 75 mm, thickness of 0.501 mm
Flatness (thickness unevenness) . . . GBIR of less than 0.5 m
Surface condition . . . Scratch: B
   (c1-2) Polishing Composition:

The polishing compositions of Examples 1 to 17 and Comparative Examples 1 and 2 obtained above were used. Details of each polishing composition are shown in Tables 1 and 2.

(c1-3) Polishing Conditions:
Polishing apparatus: double-side polishing machine 6BN (Hamai Sangyo K.K.)
Surface plate diameter: 380 mm
Polishing pad:
(a) Suede pad (Shore A 73.0) (product name: K-1W-202U-SD, manufactured by Fujibo Ehime Co., Ltd.)
(b) Polyurethane pad (Shore D 43.0, Shore A 95) (product name: TYN13MP, manufactured by Fujibo Ehime Co., Ltd.) (In Tables 1 and 2, polyurethane is expressed as PU)
(c) Nonwoven pad (Shore A 67.0) (SUBA 800 manufactured by NITTA DuPont Incorporated)
Rotation speed of lower surface plate: 45 rpm
Rotation speed of upper surface plate: 0 rpm
Internal gear: 60%
Sun gear (normal rotation): 150%
Polishing pressure: 2.9 psi
Flow rate of polishing composition (slurry flow rate): 5 mL/min, 10 mL/min, or 25 mL/min
Polishing time: 5 minutes
   (c2-1) Object to be Polished:
Object to be polished after rough polishing obtained through above (a) rough polishing (episulfide-based resin base material): circular substrate having a diameter of 75 mm, thickness of 0.502 mm
Flatness (thickness unevenness) . . . GBIR of less than 0.5 m
Surface condition . . . Scratch: C
   (c2-2) Polishing Composition:

The polishing composition of Example 9 obtained above was used. Details of the polishing composition are shown in Table 2.

(c2-3) Polishing Conditions:
Polishing apparatus: double-side polishing machine 6BN (Hamai Sangyo K.K.)
Surface plate diameter: 380 [mm]
Polishing pad (Shore A 73.0) (product name: K-1B-041U, manufactured by Fujibo Ehime Co., Ltd.)
Rotation speed of lower surface plate: 45 rpm
Rotation speed of upper surface plate: 0 rpm
Internal gear: 60%
Sun gear (normal rotation): 150%
Polishing pressure: 2.9 psi
Flow rate of polishing composition (slurry flow rate): 10 mL/min
Polishing time: 10 minutes

### <<Evaluation Method>>

After the (c) fine polishing was performed, the polishing removal rate of the object to be polished (episulfide-based resin base material) was evaluated for the object to be polished after the fine polishing according to the following polishing removal rate evaluation method. In addition, scratches on the surface of the object to be polished (surface of episulfide-based resin base material) after polishing were evaluated according to the following scratch evaluation method.

### (Polishing Removal Rate Evaluation Method)

1. The mass of the object to be polished before and after polishing was measured using an analytical balance XS205 (manufactured by Mettler-Toledo), and the mass change amount ΔM [kg] of the object to be polished before and after polishing was calculated from the difference therebetween;
2. The volume change amount ΔV [m³] of the object to be polished before and after polishing was calculated by dividing the mass change amount ΔM [kg] of the object to be polished before and after polishing by the specific gravity of the object to be polished (calculated as specific gravity of material to be polished:resin specific gravity 1.41);
3. The thickness change amount Δd [m] of the object to be polished before and after polishing was calculated by dividing the volume change amount ΔV [m³] of the object to be polished before and after polishing by the area s [m²] of the polished surface of the object to be polished;
4. The unit was further converted to [nm/min] by dividing the thickness change amount Δd [m] of the object to be polished before and after polishing by the polishing time t [min]. This value was defined as a polishing removal rate v [nm/min].

### (Scratch Evaluation Method)

Fine polishing was performed under the above conditions, the state of the surface of the object to be polished (episulfide-based resin base material) after fine polishing was measured, and scratches were evaluated according to the following evaluation criteria. When the evaluation is A or B, this case is practical. Here, the scratch is a scratch having a depth of less than 100 nm measured using an atomic force microscope (AFM) (AFM Park NX-HDM manufactured by Park Systems Corporation).

### Evaluation Criteria;

A: Under halogen light source, no scratches or one scratch is visible;
B: Under halogen light source, two or more and nine or less scratches are visible;
C: Under halogen light source, ten or more scratches are visible.

### (Thickness Unevenness (GBIR) Evaluation Method)

GBIR (edge exclusion area: 5 mm) was measured in accordance with the SEMI standard using a flatness measuring apparatus “Flatness Tester FT-900” manufactured by NIDEK CO., LTD. The obtained measured values were evaluated in the following seven stages. A smaller value of GBIR means flatness and less thickness unevenness.

### Evaluation Criteria;

<0.5: less than 0.5 m
0.5 to 1: 0.5 μm or more and 1.0 μm or less
1<<1.5: more than 1.0 μm and less than 1.5 m
1.5 to 2: 1.5 μm or more and 2.0 μm or less
2<<2.5: more than 2.0 μm and less than 2.5 m
2.5 to 3: 2.5 μm or more and 3.0 μm or less
>3: more than 3.0 μm.

### (Method of Evaluating Root Mean Square Height (Rms))

In accordance with JIS B 0601:2013, a non-contact 3D surface shape measurement was performed using a white light interferometer using a Zygo NewView9000 (manufactured by Ametech Co., Ltd.) to measure the root mean square height (Rms). The smaller the root mean square height (Rms) value, the smoother the surface.

As described above, as a result of performing the fine polishing step using each of the polishing compositions of Examples 1 to 17 and Comparative Examples 1 and 2, the thickness of the object to be polished after fine polishing with each of the polishing compositions was within the range of 0.497 mm or more and 0.500 mm or less. The evaluation results of the polishing removal rate, GBIR, and scratches are respectively shown in Tables 1 and 2 below.

TABLE 1

| | Abrasive grains (silica) | | | | | | | | | | |
|---|---|---|---|---|---|---|---|---|---|---|---|
| | | | | | Shape | | | | | Polishing | |
| | | | | | irregularity N | Particle size | | | | accelerator | |
| | | | Specific | | value of | distribution | | | | Concentration | |
| | | | surface | | particle = | | | | | (% by mass) | |
| | Concentration | Density | area (m²/g) | | SA/SA′ | Particle size (nm) | | | | Aluminum | |
| | (% by mass) | (g/cm²) | SA | SA′ | SA/SA′ | D₁₀ | D₅₀ | D₉₀ | D₉₀/D₁₀ | nitrate | PVP |
| Comparative | 15 | 1.8 | 185 | 163 | 1.1 | 15 | 21 | 26 | 1.7 | — | — |
| Example 1 | | | | | | | | | | | |
| Example 1 | 20 | 2.2 | 30 | 15 | 2.1 | 117 | 187 | 312 | 2.7 | — | — |
| Example 2 | 20 | 2.2 | 30 | 15 | 2.1 | 117 | 187 | 312 | 2.7 | — | — |
| Example 3 | 20 | 2.2 | 30 | 15 | 2.1 | 117 | 187 | 312 | 2.7 | — | — |

| | Properties and evaluation of | | | | | | | | |
|---|---|---|---|---|---|---|---|---|---|
| | polishing composition | | | | | Manufacturing conditions | | | |
| | | Polishing | | | | | Slurry | | |
| | | removal | | | | | flow | Pad | |
| | | rate | GBIR | Rms | | Middle | rate | | Shore |
| | pH | (nm/min) | (μm) | (nm) | Scratch | step | (mL/min) | Type | A |
| Comparative | 10 | 7 | >2 | 0.30 | A | carried | 25 | Suede | 73 |
| Example 1 | | | | | | out. | | | |
| Example 1 | 7 | 30 | 1.5~2 | 0.42 | A | carried | | | 73 |
| | | | | | | out. | | | |
| Example 2 | 7 | 33 | 1.5~2 | 0.46 | A | carried | | | 50 |
| | | | | | | out. | | | |
| Example 3 | 7 | 27 | 1~1.5 | 1.44 | B | carried | | Nonwoven | 67 |
| | | | | | | out. | | fabric | |

TABLE 2

| | Abrasive grains (silica) | | | | | | | | | | |
|---|---|---|---|---|---|---|---|---|---|---|---|
| | | | | | Shape | | | | | Polishing | |
| | | | | | irregularity N | Particle size | | | | accelerator | |
| | | | Specific | | value of | distribution | | | | Concentration | |
| | | | surface | | particle = | | | | | (% by mass) | |
| | Concentration | Density | area (m²/g) | | SA/SA′ | Particle size (nm) | | | | Aluminum | |
| | (% by mass) | (g/cm²) | SA | SA′ | SA/SA′ | D₁₀ | D₅₀ | D₉₀ | D₉₀/D₁₀ | nitrate | PVP |
| Comparative | 15 | 1.8 | 185 | 163 | 1.1 | 15 | 21 | 26 | 1.7 | 8.0 | 0.01 |
| Example 2 | | | | | | | | | | | |
| Example 4 | 15 | 1.8 | 74 | 63 | 1.2 | 38 | 53 | 70 | 1.8 | 8.0 | 0.01 |
| Example 5 | 15 | 2.2 | 78 | 44 | 1.8 | 39 | 62 | 83 | 2.1 | 8.0 | 0.01 |
| Example 6 | 15 | 1.8 | 34 | 29 | 1.2 | 75 | 96 | 121 | 1.6 | 8.0 | 0.01 |
| Example 7 | 15 | 1.8 | 83 | 43 | 1.9 | 42 | 64 | 106 | 2.6 | 8.0 | 0.01 |
| Example 8 | 15 | 2.2 | 30 | 15 | 2.1 | 117 | 187 | 312 | 2.7 | 8.0 | 0.01 |
| Example 9 | 15 | 2.2 | 30 | 15 | 2.1 | 117 | 187 | 312 | 2.7 | 8.0 | 0.01 |
| Example 10 | 15 | 2.2 | 30 | 15 | 2.1 | 117 | 187 | 312 | 2.7 | 8.0 | 0.01 |
| Exemple 11 | 15 | 2.2 | 30 | 15 | 2.1 | 117 | 167 | 312 | 2.7 | 8.0 | 0.01 |
| Example 12 | 15 | 2.2 | 30 | 15 | 2.1 | 117 | 187 | 312 | 2.7 | 8.0 | 0.01 |
| Example 13 | 15 | 2.2 | 30 | 15 | 2.1 | 117 | 187 | 312 | 2.7 | 8.0 | 0.01 |
| Example 14 | 15 | 2.2 | 30 | 15 | 2.1 | 117 | 187 | 312 | 2.7 | 8.0 | 0.01 |
| Example 15 | 15 | 2.2 | 30 | 15 | 2.1 | 117 | 187 | 312 | 2.7 | 8.0 | 0.01 |
| Example 16 | 15 | 2.2 | 30 | 15 | 2.1 | 117 | 187 | 312 | 2.7 | 8.0 | — |
| Example 17 | 15 | 2.2 | 30 | 15 | 2.1 | 117 | 187 | 312 | 2.7 | — | 0.01 |

| | Properties and evaluation of | | | | | | | | |
|---|---|---|---|---|---|---|---|---|---|
| | polishing composition | | | | | Manufacturing conditions | | | |
| | | Polishing | | | | | Slurry | | |
| | | removal | | | | | flow | Pad | |
| | | rate | GBIR | Rms | | Middle | rate | | Shore |
| | pH | (nm/min) | (μm) | (nm) | Scratch | step | (mL/min) | Type | A |
| Comparative | 3 | 26 | 1.5~2 | 0.25 | A | carried out. | 10 | Suede | 73 |
| Example 2 | | | | | | | | | |
| Example 4 | 3 | 50 | 1~1.5 | 0.31 | A | carried out. | | | |
| Example 5 | 3 | 75 | 1~1.5 | 0.37 | A | carried out. | | | |
| Example 6 | 3 | 136 | 0.5~1 | 0.38 | | carried out. | | | |
| Example 7 | 3 | 180 | <0.5 | 0.42 | A | carried out. | | | |
| Example 8 | 3 | 219 | <0.5 | 0.45 | A | carried out. | | | |
| Example 9 | 3 | 221 | 0.5~1 | 0.43 | A | None | | | |
| Example 10 | 3 | 191 | 1.5~2 | 0.44 | A | carried out. | | | 40 |
| Exemple 11 | 3 | 204 | 1~1.5 | 0.42 | A | carried out. | | | 50 |
| Example 12 | 3 | 205 | <0.5 | 1.17 | B | carried out. | | PU | 95 |
| Example 13 | 3 | 214 | <0.5 | 1.35 | B | carried out. | | Nonwoven | 67 |
| | | | | | | | | fabric | |
| Example 14 | 3 | 184 | <0.5 | 0.47 | A | carried out. | 5 | Suede | 73 |
| Example 15 | 3 | 228 | 0.5~1 | 0.38 | A | carried out. | 25 | | |
| Example 16 | 3 | 192 | <0.5 | 0.44 | A | carried out. | 10 | | |
| Example 17 | 7 | 157 | <0.5 | 0.40 | A | carried out. | | | |

As is apparent from Tables 1 and 2 above, it was shown that the polishing compositions of Examples are excellent in the effect of improving the polishing removal rate of the object to be polished (episulfide-based resin base material) and the effect of reducing the thickness unevenness of the object to be polished (episulfide-based resin base material) after polishing. Meanwhile, it was shown that the polishing composition of Comparative Examples was inferior to Examples in any one or more of the polishing removal rate of the object to be polished (episulfide-based resin base material) and the thickness unevenness of the object to be polished (episulfide-based resin base material) after polishing. In addition, in the polishing composition of Comparative Example (8% by mass of aluminum sulfate and 0.1% by mass of PVP as polishing accelerators, pH 6.8; Not listed in Tables 1 and 2 above) using alumina particles (12.5% by mass content, average primary particle size D₅₀: 0.7 μm) as abrasive grains, polishing was performed under the same polishing conditions as in Example 7, but using AFM, defects with scratch depths of 100 nm or more were observed, which affected the surface quality achieved in the polishing step.

The present application is based on Japanese Patent Application No. 2024-054024 filed on Mar. 28, 2024 and Japanese Patent Application No. 2025-049365 filed on Mar. 25, 2025, the disclosure content of which is incorporated herein by reference in its entirety.

What is claimed is:

1. A polishing composition used for polishing an object to be polished comprising a resin material, wherein
a silica particle, and water are comprised, and
the silica particle has a secondary particle size D₅₀ of 50 nm or more.

2. The polishing composition according to claim 1, further comprising a polishing accelerator, and the polishing accelerator is one or more selected from the group consisting of a monovalent acid aluminum salt, a pyrrolidone compound, and a caprolactam compound.

3. The polishing composition according to claim 1, wherein in the silica particles, a shape irregularity N represented by the shape irregularity N=SA/SA′ is 1.2 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′.

4. The polishing composition according to claim 1, wherein the silica particle has a secondary particle size D₅₀ of 50 nm or more and less than 200 nm.

5. The polishing composition according to claim 2, wherein the polishing accelerator comprises the monovalent acid aluminum salt and the pyrrolidone compound.

6. The polishing composition according to claim 1, wherein in the silica particles, a ratio of D₉₀ to D₁₀ (D₉₀/D₁₀) is 2.0 or more, when a particle size at which a cumulative frequency from a small particle size side in a volume-based particle size distribution of the silica particles is 10% is defined as D₁₀, and a particle size at which a cumulative frequency from a small particle size side in a volume-based particle size distribution of the silica particles is 90% is defined as D₉₀.

7. The polishing composition according to claim 1, wherein the resin material is an optical resin material.

8. The polishing composition according to claim 1, wherein an average thickness of the object to be polished before polishing is 1 mm or less.

9. The polishing composition according to claim 1, wherein flatness defined by GBIR of the object to be polished after polishing is 1.5 μm or less.

10. A polishing composition used for polishing an object to be polished comprising a resin material, wherein
a silica particle, a polishing accelerator, and water are comprised,
the polishing accelerator is one or more selected from the group consisting of a monovalent acid aluminum salt, a pyrrolidone compound, and a caprolactam compound, and
in the silica particles, a shape irregularity N represented by the shape irregularity N=SA/SA′ is 1.5 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′.

11. A polishing method comprising: a step of polishing an object to be polished containing a resin material, using the polishing composition according to claim 1.

12. A method for manufacturing an optical member, the method comprising: a step of polishing an optical resin material by the polishing method according to claim 11.

13. A polishing method comprising supplying a polishing composition between an object to be polished comprising a resin material and a polishing pad to polish the object, wherein
the polishing composition comprises silica and water, and
the silica particle has a secondary particle size D₅₀ of 50 nm or more.

14. The polishing method according to claim 13, wherein the polishing pad has a Shore A hardness of 40 or more.

15. The polishing method according to claim 13, wherein the polishing composition further further comprise a polishing accelerator, and the polishing accelerator is one or more selected from the group consisting of a monovalent acid aluminum salt, a pyrrolidone compound, and a caprolactam compound.

16. The polishing method according to claim 13, wherein in the silica particles, a shape irregularity N represented by the shape irregularity N=SA/SA′ is 1.2 or more, when a particle size at which a cumulative frequency from a small particle size side in a volume-based particle size distribution of the silica particles is 50% is defined as D₅₀, a BET specific surface area is defined as SA, and a theoretical specific surface area calculated from the D₅₀ is defined as SA′.

17. The polishing method according to claim 13, wherein the silica particle has a secondary particle size D₅₀ of 50 nm or more and less than 200 nm.

18. The polishing method according to claim 13, wherein flatness defined by GBIR of the object to be polished after polishing is 1.5 μm or less.
